(19) United States
(12) Patent Application Publication
(10) Pub. No.: US 2006/0131236 A1
(43) Pub. Date: Jun. 22, 2006

(54) Model for microfiltration of poly-disperse suspensions

(76) Inventors: Georges Belfort, Slingerlands, NY (US); Gautam Lal Baruah, Buffalo Grove, IL (US)

Correspondence Address: Michael L Goldman;Nixon Peabody, Clinton Square, P O Box 31051, Rochester, NY, 14603-1051, US

(21) Appl. No.: 10/524,508

(22) PCT Filed: Aug. 13, 2003
(86) PCT No.: PCT/US03/25230

§ 371 Date: Dec. 22, 2005

Related U.S. Application Data
(60) Provisional application No. 60/403,575, filed on Aug. 14, 2002.
(60) Provisional application No. 60/471,603, filed on May 19, 2003.

(51) Int. Cl. B01D 61/00

(52) U.S. Cl. 210/650; 210/652; 73/38; 73/40

(57) ABSTRACT

The present invention relates to a method for predicting pressure independent permeation flux and target molecule yield in a permeate resulting from crossflow filtration of particles in a poly-disperse suspension, a method for determining packing density of particles at the membrane wall of a poly-dissperse suspension, a method for designing a filtration system for a poly-disperse suspension, a method of selecting operating conditions of a crossflow filtration system for poly-disperse suspensions, and a method of modeling a process for filtration of a poly-disperse suspension using a computer generated program for predicting pressure indendent permeation flux and taret molecule yield.

This application claims the benefit of U.S. Provisional Patent Application Ser. No. 60/403,575, filed Aug. 14, 2002, and U.S. Provisional Patent Application Ser. No. 60/471,603, filed May 19,2003.

### FIELD OF THE INVENTION

The present invention relates to a model for microfiltration of poly-disperse suspensions and solutions.

### BACKGROUND OF THE INVENTION

There are presently many solutions containing macromolecular and suspended particles that are being filtered with synthetic membranes. These include waste water, surface water, automotive paint streams, and a host of streams from the biomedical and bioprocessing industries containing proteins, cells, DNA, fat globules, colloids, milk; suspended particles etc,. Microfiltration of cell culture, fermentation broths, blood, and milk are representative examples of streams from the latter industries. (Belfort et al., “The Behavior of Suspensions and Macromolecular Solutions in Crossflow Microfiltration,” J. Membr. Sci. 96:1-58 (1994); Nagata et al., “Crossflow Membrane Microfiltration of a Bacterial Fermentation Broth,” Biotecitnol. Bioeng. 34:447-466 (1988)). Because of the complex nature of these fluids, and due to the difficulty in specifying the behavior of their suspended and dissolved components, modeling microfiltration has been difficult. Belfort and coworkers have summarized the behavior of suspended particles during microfiltration. (Green et al., “Fouling of Ultrafiltration Membranes: Lateral Migration and the Particle Trajectory Model,” Desalination, 35:129-147 (1980); Altena et al., “Lateral Migration of Spherical Particles in Porous Channels: Application to Membrane Filtration,” Chem. Eng. Sci. 39:343-355 (1984); Altena et al., “Lateral Migration of Spherical Particles in Porous Tube Flows: Channels: Application to Membrane Filtration,” Physico-Chem. Hydrodyn 6:393413 (1985)). Other researchers have studied the behavior of macromolecules during microfiltration (Zydney et al., “A Concentration Polarization Model for the Filtrate Permeation Flux in Crossflow Microfiltration of Particulate Suspensions,” Chzem. Eng. Commun. 47:1-21 (1986); Rautenbach et al., “Ultrafiltration of Macromolecular Solutions and Crossflow Microfiltration of Colloidal Suspensions. A Contribution to Permeate Permeation Flux Calculations,” J. Membr. Sci. 36:231-242 (1988); Samuelsson et al., “redicting Limiting Permeation Flux of Skim Milk in Crossflow Microfiltration,” J. Membr. Sci. 129:277-281 (1997); Romero et al., “Global Model of Crossflow Microfiltration Based on Hydrodynamic Particle Diffusion,” J. Membr. Sci. 39:157-185 (1988)). Only a few studies have been reported in the literature on modeling the behavior of poly-disperse feeds containing both macromolecules and suspended particles for microfiltration (Dharmappa et al., “A Comprehensive Model for Crossflow Filtration Incorporating Polydispersity of the Influent,” J. Membr. Sci. 65:173-185 (1992); Ould-Dris et al., “Effect of Cake Thickness and Particle Polydispersity on Prediction of Permeate Permeation Flux in Microfiltration of Particulate Suspensions by a Hydrodynamic Difflusion Model,” J. Membr. Sci. 164:211-227 (2000)).

Crossflow (also known as tangential) microfiltration is a very complex phenomenon. Some of the variables which influence permeation flux and retention are membrane type and chemistry, module geometry, particle size distribution, nature of particles, interaction between individual particles and between particles and the membrane, fluid dynamics, operating mode, temperature, and pH and ionic strength of the media. This is a formidable set of variables and, to date, no unified theory exists to give a rigorous expression of permeation flux and retention for crossflow microfiltration. Existing theories render the problem tractable by concentrating on, at best, only a few aspects of the problem. Therefore, for any given case, different theories may yield widely divergent results. In applying a theoretical model, extreme care must be exercised to check the specifics of the case and critically evaluate the dominant parameters and compare these with the model assumptions. It is quite possible, particularly in dealing with complex suspensions, that no one phenomenon or class of phenomena is dominant. In such a case, an existing model may not give the true picture and a new model may need to be evolved to capture the dominant phenomena Usually, with the onset of microffitration at constant transmembrane pressure, there is a rapid decline of permeation flux due to concentration polarization and pore constriction, followed by a quasi steady state where there is a gradual decline in permeation flux due to particle deposition and increase in particle concentration (and hence viscosity) of the bulk solution (Belfort et al., “The Behavior of Suspensions and Macromolecular Solutions in Crossflow Microfiltration,” J. Membr. Sci. 96:1-58 (1994); Nagata et al., “Crossflow Membrane Microfiltration of a Bacterial Fermentation Broth,” Biotechnol. Bioeng. 34:447466 (1988)). Several models exist which attempt to evaluate the quasi steady state permeation flux. These models are based on equilibrium between transport to and back-transport of particles from the membrane wall. It is important to note that these models are valid in the laminar flow regime for fully retentive membranes, deal with the pressure-independent permeation flux regime, and ignore particle interaction with the membrane. Prediction of permeation flux in the pressure-dependent and transient regimes has been addressed by Romero and Davis (Romero et al., “Global Model of Crossflow Microfiltration Based on Hydrodynamic Particle Diffusion,” J. Membr. Sci. 39:157-185 (1988); Romero et al., “Transient Model of Crossflow Microfiltration,” Chem. Eng. Sci. 45:13-25 (1990)). A simplified version ofthe gel-polarizationmodel for describing concentration polarization in ultrafiltration for fully retentive membranes, originally presented by Blatt et al., “Solute Polarization and Cake Formation in Membrane Ultrafiltration: Causes, Consequences and Control Techniques,” in Membrane Science and Technology, J. E. Flinn, ed., New York:Plenum, pp. 47-97 (1970), is given by the permeation flux at an axial position x along the flow path,
J(x)=k(x)In(φ_{w}/φ₀) (1)
where the membrane and cake resistances do not appear in this formulation and k(x), the mass transfer coefficient is given by the ratio of the molecular diffusion coefficient, D, to the x—dependent mass boundary layer thickness, δ(x).

Using the Leveque solution for laminar flow in a closed tube and the Stokes-Einstein relationship for Brownian diffusion of mono-dispersed spheres of radius a, Eq. (1) changes to Eq. (2), shown in Table 1. The Brownian (molecular) diffusion model is valid for particle diameters below ˜0.1 μM and at low axial shear rates. For microfiltration situations where α>1 μm, Eq. (2) under-predicts the permeation flux by one to two orders of magnitude. Green and Belfort (Green et al., “Fouling of Ultrafiltration Membranes: Lateral Migration and the Particle Trajectory Model,” Desalination, 35:129-147 (1980)), referring to this as the flux paradox, searched for mechanisms that induce back-migration from the membrane surface in addition to molecular diffusion. Belfort and coworkers invoked inertial lift as an additional back (or lateral) migration mechanism and used it to explain the discrepancy in permeation flux mentioned above (Green et al., “Fouling of Ultrafiltration Membranes: Lateral Migration and the Particle TrajectoryModel,” Desalination, 35:129-147 (1980); Altena et al., “Lateral Migration of Spherical Particles in Porous Channels: Application to Membrane Filtration,” Chem. Eng. Sci. 39:343-355 (1984); Altena et al., “Lateral Migration of Spherical Particles in Porous Tube Flows: Channels: Application to Membrane Filtration,” Physico-chem. Hydrodyn. 6:393-413 (1985)). Their expression for permeation flux is given by Eq. (3) in Table 1. This model is applicable for dilute solutions containing large particles (>20 μm) and high axial shear stress or fast laminar flow situations. Zydney and Colton (Zydney et al., “A Concentration Polarization Model for the Filtrate Permeation Flux in Crossflow Microfiltration of Particulate Suspensions,” Chem. Eng. Commun. 47:1-21 (1986)) resolved the permeation flux paradox by proposing that the gel-concentration polarization model should be used, provided the molecular diffusion term in the Leveque solution is replaced by the shear-induced hydrodynamic diffusivity (and the permeation flux is averaged over the axial flow path), first measured by Eckstein et al, “Self-Diffusion of Particles in Shear Flow of a Suspension,” J. Fluid Mech. 79:191-208 (1977)). This model, given by Eq. (4) in Table 1, has been experimentally validated for latex and blood suspensions for a broad range of conditions. It is suitable for particles in the diameter size range 0.1 to 20 μm. Li et al., “An Assessment of Depolarization Models of Crossflow Microfiltration by Direct Observation through the Membrane,” J. Membr. Sci. 172:135-147 (2000)), based on direct observation of particle dynamics during membrane filtration, suggested that the coefficient in Eq. (4) should be replaced with 0.0595. Using a similarity solution, Davis and Sherwood (Davis et al., “A Similarity Solution for Steady-State Crossflow Microfiltration,” Chem Eng. Sci. 45:3203-3209 (1990); Ho et al., Membrane Handbook, New York:Van Nostrand Reinhold; pp 480-505 (1992)) have accounted for a concentration-dependent fluid viscosity and diffsivity and obtained Eq. (5), shown in Table 1. The results from this expression agree with those from Eq. (4) to within 15% for φ_{b}=0.01 and φ_{w}=0.6, which is close to the maximum for monodisperse rigid spherical particles.

TABLE 1

| Flux Model | Approaches | Flux Equation | Eqn.#'s | Applicable range | Reference |
|---|---|---|---|---|---|
| Brownian diffusion | Use Leveque solution | J=0.114(γκ²T²/η²α²L)^{1/3}ln(φ_{w}/φₒ) | (2) | Applicable for very | Blatt et al. |
| | for laminar flow in a | | | small diameter | Membrane Sci. & |
| | closed tube and Stokes- | | | particles (<1 μm). | Techn. J., E. Flinn, |
| | Einstein relationship | | | Under predicts flux by | ed., New York, |
| | for Brownian diffusion. | | | one to two orders of | Plenum, pp. 47-97 |
| | | | | magnitude for large | (1970) |
| | | | | particles | |
| Inertial lift | Include the inertial | J=0.036 ρα³γ²/η | (3) | Applicable for large | Belfort, et al |
| | terms in solving the | | | diameter particles (> | Desalination, |
| | force balance around a | | | 20 μm) and considers | 35:129-147 (1980); |
| | single particle | | | only single particles | Chem. Eng. Sci. |
| | | | | | 39:343-355 (1984); |
| | | | | | Physico-Chem. |
| | | | | | Hydrodyn 6:393-413 |
| | | | | | (1985) |
| Shear induced | Replace diffusion | J=0.078(α⁴/L)^{1/3}γln(φ_{w}/φₒ) | (4) | Applicable for | Zydney et al., |
| diffusion | coefficient with a | | | intermediate diameter | (Chem. Eng. |
| | shear-dependent term | | | particles (1-20 μm) | Commun. 47:1-21 |
| | from Eckstein et al (14) | | | | (1986) |
| Concentration- | Uses a numerical and | J=0.072(α⁴/L)^{1/3}γ(φ_{w}/φₒ)^{1/3} | (5) | Similar to Eq. (4) | Davis and Sherwood |
| dependent diffusion | similarity solutions, | | | above | Chem. Eng. Sci. |
| and viscosity | accounts for | | | | 45:13-25 (1990); |
| | concentration effects in | | | | Chem. Eng. Sci. |
| | diffusion and viscosity | | | | 45:3203-09 (1990) |

The models discussed above deal with crossflow microfiltration of idealized mono-disperse streams, whereas most real microfiltration applications deal with poly-disperse feed streams with particle sizes ranging from the macromolecular to the colloidal. This has generated the need to develop a generally applicable model useful for predicting length-averaged permeation flux and yield of target molecules for poly-disperse feeds under a variety of filtration conditions.

The present invention is directed to overcoming these and other deficiencies in the art.

### SUMMARY OF THE INVENTION

The present invention relates to a method for predicting pressure independent permeation flux and target molecule yield in a permeate resulting from crossflow membrane filtration of particles in a poly-disperse suspension. This method involves determining the particle size distribution of the poly-disperse suspension, the equivalent spherical radii of the particles, the viscosity of the suspension, and the maximum back-transport velocity (uᵢ) for all particles. It also involves estimating the maximum aggregate packing volume fraction (μ_{M}) for all particles at a wall of the filtration membrane from geometric considerations, and selecting the particle that gives a minimum permeation flux at a given filtration membrane shear rate, where the selected particle has a radius (αᵢ), and determining a predicted permeation flux. The method also involves determining packing density at φ_{wi} a membrane wall for each particle size (αⱼ for j≠i) at the predicted permeation flux. Also determined are interstitial packing density (O_{wiinterstice}) of particles in the suspension which are smallest, and minimum pore diameter (2rₘᵢₙᵢₘᵤₘ) based on the packing density of each particle. The yield of a target species in the filtration permeate is then estimated by calculating observed sieving coefficient (Sₒ) for the target species. As a result, permeation flux and target molecule yield of the poly-disperse suspension during crossflow filtration are predicted.

The present invention also relates to a method for determining the packing density of particles of a poly-disperse suspension at a membrane wall. This method involves providing a predicted permeation flux (J), determining the packing density for all particle sizes at the predicted permeation flux, and determining interstitial packing density (φ_{wiinterstice}) of particles in the suspension which are smallest, thereby determining the packing density at the membrane wall of particles of the poly-disperse suspension.

Another aspect of the present invention is a method for predicting pressure independent permeation flux for crossflow membrane filtration of a poly-disperse suspension. This method involves determining the viscosity of the suspension, determining the maximum back-transport velocity (uᵢ) for all particles, and estimating the maximum aggregate packing volume fraction (φ_{M}) for all particles at a wall of the filtration membrane wall from geometric considerations. The particle that gives a minimum permeation flux at a given filtration membrane shear rate is selected, where the selected particle has a radius (αᵢ). A predicted permeation flux (J) is determined, and the packing density (ha) at the membrane wall for each particle size (αⱼ for j≠i) is determined at the predicted permeation flux.

Another aspect of the present invention is a method for calculating yield of a target molecule in a permeate for a poly-disperse suspension during crossflow membrane filtration. This method involves determning the minimum pore diameter (2rₘᵢₙᵢₘᵤₘ) based on the packing density of each particle, and estimating the yield of a target species in the filtration permeate by calculating the observed sieving coefficient (Sₒ) for the target species.

The present invention also relates to a method for designing a crossflow membrane filtration system for a poly-disperse suspension. This method involves selecting a poly-disperse suspension and predicting pressure independent permeation flux and target molecule yield in a permeate resulting from crossflow membrane filtration of particles in a poly-disperse suspension as described above. Conditions for filtration based on the prediction of permeation flux and target molecule yield are then optimized to design a filtration system for the selected poly-disperse suspension.

Yet another aspect of the present invention is a method of selecting operating conditions of a crossflow filtration system for poly-disperse suspensions. This method involves predicting the pressure independent permeation flux and target molecule yield in a permeate resulting from crossflow membrane filtration of particles in a poly-disperse suspension as described above. Operating conditions of the system are selected using the limiting pressure independent permeation flux determined for a given shear rate to obtain an optimal balance between permeation flux and yield of a target species.

The present invention also relates to a method of modeling a process for filtration of a poly-disperse suspension. This method involves applying the method for predicting pressure independent permeation flux and target molecule yield in a permeate resulting from crossflow membrane filtration of particles in a poly-disperse suspension, as described above, and using a computer-generated program to model a process for filtration of a poly-disperse suspension.

Most microfiltration applications deal with poly-disperse feed streams with particle sizes ranging from the macromolecular to the colloidal. This has generated the need to develop a model which can predict the pressure independent permeation flux, a priori, and can provide an estimate of the yield of target molecules (i.e., the product concentration in the permeate) in the permeate for poly-disperse suspensions. Thus, the present invention relates to a method for calculating yield of a target molecule in a permeate for a poly-disperse suspension during crossflow membrane filtration. The iterative methodology is capable of predicting crossflow microfiltration performance of poly-disperse suspensions in a variety of settings. For example, it is suitable for filtration of a poly-disperse suspension of waste water, surface water, paints, metallurgical wastes, environmental pollutants, industrial waste streams and streams from biochemical and bio-processing industries containing proteins, cells, DNA, colloids, milk, suspended particles etc.

Several researchers have reported that there exists a critical ratio between permeation flux and wall shear rate beyond which protein transmission drops drastically and permeation flux does not increase with increasing transmembrane pressure (Berre et al., “Skim Milk Crossflow Microfiltration Performance Versus Permeation Flux to Wall Shear Stress Ratio,” J. Membr. Sci. 117:261-270 (1996); Gesan-Guiziou et al., “Critical Stability Conditions in Crossflow Microfiltration of Skimmed Milk: Transition to Irreversible Deposition,” J. Membr. Sci. 158:211-222 (1999); Gesan-Guiziou et al., “Performance of Whey Crossflow Microfiltration During Transient and Stationary Operating Conditions,” J. Membr. Sci. 104:271-281 (1995); Gesan-Guiziou et al., “Critical Stability Conditions in Skimmed Milk Crossflow Microfiltration: Impact on Operating Modes,” Lait 80:129-140 (2000)). The method presented here provides a quantitative framework to explain this phenomenon and also provides the rationale for operating at uniform axial transmembrane pressure along the flow path.

For simplicity, the adhesion of particles to the surface of the membrane, charge interactions between particles and the membrane, and between particles, are ignored. Several papers have demonstrated that electrostatic effects actually can increase permeation flux during filtration (Zydney et al., “Intermolecular Electrostatic Interactions and Their Effect on Permeation Flux and Protein Deposition During Protein Filtration,” Biotechnol. Prog. 10:207-213 (1994); Aimar et al., “Fouling and Concentration Polarization in Ultrafiltration and Microfiltration,” Membrane Processes in Separation and Purification, Crespo et al., eds., Dordrecht, Boston, London:Kluwer Academic Publishers (1994)). Under these conditions, this renders the current approach conservative and compensates to some extent for neglecting particle aggregation and particle adhesion to the membrane. All particles are assumed to be spherical, with volumes equal to the actual particle volumes.

The following scenario is proposed. There are three regimes of operation, as shown schematically in FIG. 1A. In the first regime, a rapid decline of permeation flux occurs with respect to the water flux, mainly due to deposits within the membrane pores leading to flow constriction. The deposits on the membrane have not yet consolidated. Instead, the deposits form a sparse layer which cannot be compressed. The permeation flux is proportional to transmembrane pressure but the slope of the line corresponds to the inverse of the resistance (or to the permeability coefficient) of the constricted and not the clean membrane. This results in a permeation flux that is lower than the clean water permeation flux. This approach therefore deviates from that suggested by Howell et al. (Howell, “Sub-Critical Permeation Flux Operation of Microfiltration,” J. Membr. Sci. 107:165-171 (1994); Field et al., “Critical Permeation Flux Concept for Microfiltration Fouling,” J. Membr. Sci., 100:259-272 (1994)), who have proposed the existence of a critical permeation flux in microfiltration below which there is no fouling at all. With an increase in transmembrane pressure, the permeation flux along with the concentration of deposits increases until the gel (Landman et al., “Pressure Filtration of Flocculated Suspensions,” AIChE J. 41:1687-1700 (1995)) concentration is exceeded. The gel concentration is that threshold concentration beyond which the deposits consolidate into an interconnected network capable of becoming denser with increasing pressure. In this regime, an increase in transmembrane pressure results not only in an increase in the permeation flux but also an increase in the cake resistance due to cake densification. Thus, the permeation flux-transmembrane pressure curve falls below and away from the initial straight line. In the third regime, the permeation flux does not increase with increasing transmembrane pressure. Layers of particles develop on the membrane surface concomitant with a deposition of particles within the pores. The particle layer adjacent to the membrane will correspond to the maximum packing density. This could range from 0.64 for rigid monodisperse spheres to 0.95 for highly deformable particles like red blood cells (Zeman et al., “Microfiltration and Ultrafiltration Principles and Applications, “New York:Marcel Dekker, Inc. (1996) or poly-disperse rigid spheres of widely different sizes. The deposition within the pore depends on the membrane chemistry. For hydrophilic membranes particle adhesion will be lower than for hydrophobic membranes for most proteins (Hanemaijier, “Microfiltration in Whey Processing,” Desalination 53:143-155 (1985); Koehler et al., “Intermolecular Forces Between Proteins and Polymer Films with Relevance to Filtration,” Langmuir 13(15):41624171 (1997)). This is because a hydrophilic membrane has a greater affinity for water in comparison with proteins, leading to the preferential formation of water layers, instead of protein layers, adjacent to the membrane. If the transmembrane pressure is increased, the particle layers above the compact layer adjacent to the membrane become denser. Therefore, the cake resistance increases and the permeation flux is maintained. This leads to a quasi steady state permeation flux as long as the bulk suspension remains the same and the operating conditions are maintained. There is a gradual decline in permeation flux due to the increase in deposits within the pores leading to higher pore constriction and a time dependent compression of the cake layer. Essentially, the cake forms due to the balance of convective transport of solutes towards the membrane with back transport of solutes from the membrane to the bulk and the solute transport through the membrane. The cake and the constricted membrane provide the necessary resistances to maintain the permeation flux required to achieve this balance.

A theory of cake filtration relating to the composition and sieving characteristics of the deposited cake has been developed based on an experimental determination of a rheological parameter related to the specific cake resistance. (Landman et al., “Pressure Filtration of Flocculated Suspensions,” AIChE J. 41:1687-1700 (1995)). Other researchers have experimentally evaluated the sieving characteristics of filter cakes in microfiltration formed by protein deposits (Palecek et al., “Hydraulic Permeability of Protein Deposits Formed During Microfiltration: Effect of Solution Ph and Ionic Strength,” J. Membr. Sci. 95:71-81 (1994); Meireles et al., “Effects of Protein Fouling on the Apparent Pore Size Distribution of Sieving Membranes,” J. Membr. Sci. 56:13-28 (1991) (NOTE: This paper has a definitional error—for correction see Zydney et al., “Use of tde Log-Normal Probability Density Function to Analyze Membrane Pore Size Distributions: Functional Forms and Discrepancies,” J. Membr. Sci. 91:293-298 (1994)); Mochizuki et al., “Sieving Characteristics of Albumin Deposits Formed During Microfiltration,” J. Colloid Interface Sci. 158:136-145 (1993)). In this invention, the predominant nature of the cake is considered to be determined by the propensity of particles of different sizes to diffuse back to the bulk for a given shear rate. The cake is thought to be primarily composed of particles with the least back-transport velocity. This does not preclude the possibility of smaller particles from lodging themselves in the interstices of a compact layer of larger particles, as shown in FIG. 1B. The pacldng density and nature of the cake will correspond to that necessary, at equilibrium, to support a combination of back-transport rate and solute transport through the cake to match the convective transport of solutes to the membrane wall (i.e. the balance condition). Although the packing density of the smaller particles could be less than that of the larger particles, the interstices are smaller and could very well determine the extent of passage of particles through the cake.

### BRIEF DESCRIPTION OF THE DRAWINGS

FIGS. 1A-C are schematic representations of various parameters that influence the microfiltration of poly-disperse suspensions. FIG. 1A is a schematic of three different operating regimes during microfiltration of poly-disperse suspensions. Regime I is pore constriction. Regime II is cake consolidation. Regime III is pressure-independent flux. FIG. 1B is a schematic of a sparse cake comprising a bi-disperse mixture of large and small particles while operating in Regime I. FIG. 1C shows particle packing constraints for the test case of a face-centered cubic arrangement (explained in greater detail in Example 3): φ₁+φ₂+φ₃≦φ_{Max}; φ₁+φ₂≦constant (0.68 in this case) and φ₃≦0.74[1−(φ₁+φ₂)]. Transmission of particle of radius αᵢ,≧0 for φ_{interstice}≦0.74.

FIGS. 2A-B are graphs of predicted values for a hypothetical suspension comprising particles of three sizes. FIG. 2A is a graph of predicted values of pressure-independent permeation flux based on back-transport of particles of 10 nm (solid line), 180 nm (short dashed line), and 300 nm (long dashed line) versus mean axial shear rate. FIG. 2B is a graph of predicted values of poly-disperse pressure-independent permeation flux versus mean axial shear rate, for a 6-fiber hollow fiber module of length 300 mm, internal diameter 1.27 mm, and pore diameter of 100 nm filtering whole transgenic goat milk at 298 K.

FIG. 3 is a graph of predicted values of pressure-independent permeation flux versus mean axial shear rate for 6-fiber hollow fiber modules of various lengths. The internal diameter and pore diameter of the fibers was 1.27 mm and 100 nm, respectively.

FIG. 4 is a graph of predicted values of pressure-independent permeation flux versus mean axial shear rate for a 6-fiber hollow fiber module of length 300 mm, internal diameter 1.27 mm, and pore diameter of 100 nm at various bulk feed volume fractions.

FIG. 5 is a graph of predicted values of pressure-independent permeate flux and yield of 10 nm particles versus mean axial shear rate after diafiltration of 4 diavolumes for a 6-fiber hollow fiber module of length 300 mm, internal diameter 1.27 mm, and pore diameter of 100 nm.

FIGS. 6A-C are a schematic of variation in pressure inside the bore of a hollow fiber (P1 to P2) with varied length. FIG. 6A shows the permeate pressure in the extra-capillary space is constant at P3, where beyond an axial distance L′, the permeate pressure exceeds the retentate pressure causing permeate to flow in the reverse direction from the permeate side to the retentate side, called Starling flow. FIG. 6B shows the constant at P3 for a short axial path length such that P3<P2. In this case reverse permeation does not occur because P2>P3, as shown in FIG. 6C, is allowed to decline from P3A to P3B in the extra-capillary space as the permeate stream is pumped axially in co-flow mode with respect to the retentate stream such that the transmembrane pressure is kept constant with axial distance.

FIG. 7 is a diagram of the linear and new coiled hollow fiber design according to U.S. Pat. No. RE 37,759 to Belfort, which is hereby incorporated by reference in its entirety.

FIG. 8 is a flow diagram of the dual hollow fiber microfiltration test system used for microfiltration of transgenic goat milk.

FIGS. 9A-B are graphs of predicted pressure-independent permneation flux values. FIG. 9A is a graph of predicted values of pressure-independent permeation flux based on back-transport of particles of IgG (solid line), casein micelles (short dashed line), and fat globules (long dashed line) versus mean axial shear rate. FIG. 9B shows pressure-independent poly-disperse permeation flux versus mean axial shear rate for a 6-fiber hollow fiber module of length 300 mm, internal diameter 1.27 mm, and pore diameter of 100 nm filtering whole transgenic goat milk at 298 K.

FIG. 10 is a graph of the friction factor versus Reynolds number for linear (fall symbols) and helical (open symbols) with DI water. The solid line passing through the data for the helical modules is the Mishra and Gupta equation: f_{helical}=(64/Re)[1+0.0033(log₁₀ De)4]; and the dashed line passing through the data for the linear module is the Hagen- Poiseuiile equation: fₗᵢₙₑₐᵣ=64/Re. ▴L-1, ♦L-2, ▪L-3, ΔH-1, ⋄H-2, □H-3.

FIG. 11 is a graph of permeation flux as a function of transmembrane pressure (“TMP”) for the linear module (30 cm long) at different whole transgenic goat milk bulk protein concentrations (▪13 g/l; ♦23 g/l; ●42 g/l; ▴54 g/l; ×68 g/l). The axial Reynolds number was kept at 1500. The near vertical line (y=37x) is the permeation flux with DI water.

FIG. 12 is a graph showing permeation flux as a finction of transmembrane pressure (“TMP”) for the helical module (24.9 cm long) at different whole transgenic goat milk bulk protein concentrations (□13 g/l; ⋄23 g/l; ◯42 g/l; Δ54 g/l; ×68 g/l). The axial Reynolds number was kept at 1075. The near vertical line (y=33x) is the permeation flux with DI water.

FIG. 13 is a graph of permeation flux versus the logarithm of the protein feed concentration for various whole transgenic goat milk microfiltration runs for the linear (♦) and the helical (⋄) modules. The plot is made according to the gel polarization model J=k Ln(Cw/Cb). The resulting linear equations are y=−26.5x+161.8, r2=0.99 for the helical module indicating k_{helical}=26.5 lmh, y=−18.2x+110.9, r2=0.95 for the linear module indicating kₗᵢₙₑₐᵣ=18.2 lmh. Based on the x-intercept, GW (helical)=448 g/l and C_{w}(linear)=443 g/l. The transmembrane pressures corresponding to the pressure-independent flux were about 60 kPa for the linear and 70 kPa for the helical modules.

FIG. 14 is a graph of permeation flux versus number of diavolumes passed through the membrane for different starting concentrations of whole transgenic goat milk at 298 K and Reynolds number of 1400. The various cases are ▪Linear 1X, ●Linear 1.5X, ♦Linear 2X, ▴Linear 3X, □Helical 1X, ◯Helical 1.5X, ⋄Helical 2X, ×Helical 2.5X, ΔHelical 3X.

FIG. 15 is a graph of IgG yield versus whole transgenic goat milk starting concentration (X) for helical (open symbols) and linear (full symbols) modules at 298 K and Reynolds number of 1400 after 5 diavolumes.

FIG. 16 is a graph of observed protein sieving coefficient versus bulk protein concentration of whole transgenic goat milk for helical (open symbols) and linear (full symbols) modules at 298 K and Reynolds number of 1400.

FIG. 17 is a graph of permeation flux versus number of diavolumes passed through the membrane for 2x concentration of whole transgenic goat milk at 298 K and various Reynolds numbers. The various cases are ▴Linear Re=860, ●Linear Re=1285, ▪Linear Re=1500, ▴Linear Re=1715, ×Helical Re=643, ΔHelical Re=860, ◯Helical Re=1070, □Helical Re=1400, ⋄Helical Re=1610.

FIG. 18 is a graph of permeation flux improvement of the helical module over the linear module versus Reynold's number for 2X concentration of whole transgenic goat milk at 298 K.

FIG. 19 is a graph of predicted permeation flux versus actual flux for different temperatures, wall shear rates, and milk concentrations, r2=0.92. For the helical module, the wall shear rate is given by γhelical=1.95ylinear (Gesan-Guiziou et al., “Critical Stability Conditions in Skimmed Milk Crossfiow Microfiltration: Impact on Operating Modes,” Lait 80:129-140 (2000)) where γlinear is the wall shear rate for a linear module at the same Reynolds number, internal diameter and length as the helical module. The various cases are ▴Linear TS=10%, ♦Linear TS=12%, ▪Linear TS=13.2%, ◯Linear TS=16.5 to 20%, ΔHelical TS=10%, ⋄Helical TS=12%, ◯Helical TS=13.2%, □Helical TS=16.5 to 20%. Wall shear rates vary from 18,500 to 87,000 s-1 and temperatures from 293 to 308 K. TS=total solids. (Notes: 1) 100% sieving is assumed for lactose, minerals and non IgG whey proteins; 2) Both predicted and experimental flux values are based on the pressure independent values; 3) Electrostatic, inter-particle and particle-membrane interactions have not been considered.)

### DETAILED DESCRIPTION OF THE INVENTION

The present invention relates to a method for predicting pressure independent permeation flux and target molecule yield in a permeate resulting from crossflow membrane filtration of particles in a poly-disperse suspension. This method involves determining the particle size distribution of the poly-disperse suspension, the equivalent spherical radii of the particles, the viscosity of the suspension, and the maximum back-transport velocity (uᵢ) for all particles. It also involves estimating the maximum aggregate packing volume fraction (φ_{M}) for all particles at a wall of the filtration membrane from geometric considerations, and selecting the particle that gives a minimum permeation flux at a given filtration membrane shear rate, where the selected particle has a radius (αᵢ), and determining a predicted permeation flux. The method also involves determining pacling density (φ_{wi}) at the membrane wall for each particle size (αⱼ for j≠i) at the predicted permeation flux. Also determined are the interstitial packing density (φ_{wiinterstice}) of particles in the suspension which are smallest, and minimum pore diameter (2rₘᵢₙᵢₘᵤₘ) based on the pacling density of each particle. The yield of a target species in the filtration permeate is then estimated by calculating observed sieving coefficient (Sₒ) for the target species. As a result, permeation flux and target molecule yield of the poly-disperse suspension during crossflow filtration are predicted.

The viscosity of the poly-disperse suspension is determined by experimental data or by using a modified Einstein-Smoluchowski equation: η/η₀=1+2.5φ_{b}+k₁φ_{b}², where η is bulk fluid viscosity (kg/m.s) of the suspension, η₀ is bulk fluid viscosity of the suspension without solute (kg/m.s), k₁ is particle shape factor (−), and φ_{b} is particle volume fraction in the bulk suspension (−). Alternatively, viscosity can be determined experimentally.

Determination of the maximum back-transport velocity (uᵢ) is carried out by calculating Brownian diffusion (J_{B}) for all particles, where J_{B}=0.114(γκ²T²/η²α²L)^{1/3}ln(φ_{w}/φₒ); calculating inertial lift (J₁) for all particles, where J₁=0.036ρα³γ²/η; and calculating shear induced diffusion (J_{S}) for all particles where J_{S}=0.078(α⁴/L)^{1/3}γln(φ_{w}/φ_{b}) (see Table 1). γ is wall shear rate (s⁻¹), T is temperature (K), η is bulk fluid viscosity kg/m.s), αᵢ is radius of species i(m), L is tube length (m), φ_{w} is particle volume fraction at the filtration membrane (−), φ_{b} is the particle volume fraction in the bulk suspension (−); and ρ is particle density (kg/m³). The maximum value of J (Jₘₐₓ) is selected for each particle. This maximum value of J is=uᵢ, the maximum back-transport for each particle in the suspension.

Estimating maxiinum aggregate packing volume fraction for the poly-disperse suspension (φ_{M}) at the membrane wall is carried out by determining the particle sizes (αᵢ) in the suspension, where as is radius of species i(m), determining the size ratios of the particles, and using φ_{M}=φₘ+0.74 (1−φₘ), for a suspension or solution having two particle sizes such that α₁>10α₂, where φₘ is the maximum packing volume fraction for monodisperse spheres. Although a poly-disperse suspension is more complex than a suspension having monodisperse spheres, the value for a monodisperse sphere, i.e., φₘ=0.64, can be used in the first iteration of the present invention in order to estimate the maximum packing volume fraction. Therefore, in one aspect of the present invention, φₘ=0.64 for all particles for the first iteration. In another aspect of the present invention, maximum aggregate packing volume fraction at the membrane wall involves determining the particle sizes (αᵢ) of species (i) in the suspension, and determining if the size ratio of the particles is >10, such that αᵢ₊₁>10αᵢ for all α₁. If αᵢ₊₁>10αᵢ, the maximum aggregate packing volume fraction (φ_{Mn}) is calculated by
φ_{Mn}=φₘ+φₘ(1−φ_{Mn-1}),
where φ_{M1}=φₘ is the maximum packing volume fraction for monodisperse spheres set to 0.64.

In another aspect of the present invention, the maximum aggregate packing volume fraction (φₘ) is estimated by determinkig the particle sizes in the suspension (αᵢ) and calculating a maximum radius ratio of all the particles. If the maximum radius ratio is <10, φ_{M}=0.68 is set as the value of the maximum packing volume fraction.

Yet another aspect of the present invention provides that if the radius ratio of a suspension having two particle types is ≧10, then φ_{M}=φₘ+0.74 (1−φₘ), where φₘ may be set to 0.64 to denote the highest packing volume fraction for a single particle. The packing volume fraction (φ_{M}) at the membrane wall for a suspension having three particle sizes such that α₁>10α₂>100 α₃, is carried out by
φₘ=φₘ+φₘ(1−φₘ)+0.74[1−{φₘφₘ(1−φₘ)}]
where φₘ is the maximum packing volume fraction for monodisperse spheres set to 0.64. An extension of the above equation can be used for more than three particles. For a suspension where there are greater than three particle types, each having a size ratio greater than 10 such that, α₁>10α₂>100α₃>1000α₄, etc., the maximum aggregate packing volume fraction (φ_{Mn}) at the membrane wall can be calculated by the recursive formula
φ_{Mn}=φₘ+φₘ(1−φ_{Mn-1})
where φ_{M1}=φₘ is the maximum packing volume fraction for monodisperse spheres set to 0.64.

Determining a predicted minimum permeation flux for a poly-disperse suspension is carried out by comparing the values of (Jₘₐₓ) determined for each particle type in the suspension by calculating J_{B}, J_{I}, and J_{S} as described above. The predicted minimum permeation flux (J_{MIN}) is determined by selecting from among the (Jₘₐₓ) values for all particles the (Jₘₐₓ) for a given particle (αᵢ) having the lowest numerical value.

The packing density (φ_{wj}) for all other particles at the predicted permeation flux (αⱼ for j≠i) is also determined. This determination is carried out by calculating the value of φ_{wj} such that φ_{wj} gives the predicted permeation flux (J) of selected particle (αᵢ), using the equation for back-transport that establishes maximum back transport for each particle (αⱼ for j=i). As described above, J is calculated by either J_{B}=0.114(γκ²T²/η²α²L)^{1/3}ln(φ_{w}/φ_{b}), J₁=0.036ρα³γ²/η, or J_{S}=0.078(α⁴/L)^{1/3}γln(φ_{w}/φ_{b}). γ is wall shear rate (s⁻¹), Tis temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³). When J for (αⱼ) has been calculated using either J_{B} or J_{S}, the value of φ_{wj} can be “backed-out” of the equation mathematically. However, when J₁ is the governing back-transport mechanism, the value of φ_{wj} cannot be directly back-calculated. In that embodiment of the present invention, the value of φ_{wj} is instead calculated by estimating mass balance and the propensity of a particle to lift off from the membrane wall. In one aspect of the present invention, this can be carried out by determining if u_{jI}≧10J for the particle, where if u_{jI}≧10J, the determination of the packing density (φ_{wj}) for that particle is carried out using φ_{wjI}=0, as the particle back-transport velocity is much higher than the polydisperse permeation flux and will be readily lifted off from the membrane wall. Otherwise, i.e., if u_{jI}<10J, (φ_{wj}) for that particle is carried out using
φ_{wjI}=φ_{M}−Σφ_{wj}
where j≠jI. If there is more than one particle type whose back-transport is governed by inertial lift, jI1 and jI2, their contributions to the cake at the wall can be approximately apportioned in the direct ratio of their volume fractions in the bulk suspension and inverse ratio of their back-transport by
φ_{wjI1}+φ_{wjI2}=φ_{M}−Σφ_{wj}
φ_{wjI1}:φ_{wjI2}=φ_{bjI1}uⱼᵢ₂:φ_{bjI2} u_{jI1}
where j≠jI1 or jI2 and U_{jI1}, U_{jI2}<10J. This logic can be extended for more than two particle types whose back transport is governed by inertial lift.

In order to determine the permeation flux and target yield of a poly-disperse suspension during crossflow microfiltration, it is also necessary to determine the interstitial packing density (φ_{wiinterstice}) of the smallest particle in the suspension. This is carried out by φ_{wiinterstice}=φ_{wicorrected}/(1−Σ φ_{wjcorrected}), where φ_{wicorrected}=φ_{M}[(φ_{wi})/Σ φ_{wi}], and where φ_{wi} is the particle volume fraction at the membrane wall (−) for particle i.

Another factor to be determined in this aspect of the present invention is the minimum pore diameter (2rₘᵢₙᵢₘᵤₘ) available at the membrane wall, based on the corrected packing density of each particle. The minimum pore diameter (2rₘᵢₙᵢₘᵤₘ) is estimated from geometric considerations, based on a face centered cubic packing for the cake where there are four spherical particles per cube. Here it is assunmed that the gap available for transmission in a face centered cubic cake is (2rₘᵢₙᵢₘᵤₘ)=α√2−2αi, where a is the side of the cube and αᵢ is the radius of the particles located at the vertices and face centers of the cube. Therefore, in the present invention, 2rₘᵢₙᵢₘᵤₘ=αᵢ{√2[4(4/3)π/φ_{wiinterstice}]^{1/3}−2}, where α is radius of species i (m) and rₘᵢₙᵢₘᵤₘ is a minimum equivalent cake void radius for all cake types (m).

The method of the present invention also involves estimating yield of a target molecule. This involves calculating the observed sieving coefficient (Sₒ), where Sₒ=S_{α}/((1−S_{α})exp(−J/k)+S_{α}). The actual sieving coefficient S_{α} is obtained from S_{α}=(Sₒexp(Peₘ))/(S_{∝}+exp(Peₘ)−1), the wall Peclet number, Peₘ is obtained from Peₘ=(Jδₘ/D)(S_{∝}/εφK_{d}), δₘ is taken as the side of the face centered cube of the particles of radius αᵢ that forms the controlling cake for transmission, δₘ=α=αᵢ[(4(4/3)π)/φ_{interstice}]^{1/3}, intrinsic sieving coefficient S_{∝}is obtained from S₄(1−λ)²[2−(1−λ)²exp(−0.7146λ²), λ=rₛ/r_{min,} λ is a ratio of solute to pore radii (rₛ/rₘᵢₙ)(−), rₘᵢₙ a minimum equivalent cake void radius for all cake types (m), rₛ is solute radius (m); and φK_{d}=(1−λ)^{9/2}, where φ is the equilibrium partition coefficient between membrane pore and suspension (−), and K_{d} is a hindrance factor for diffusive transport (−).

In one aspect of the present invention, the crossflow filtration process includes diafiltration. Diafiltration is a process whereby a filtration membrane is used to remove, replace, or lower the concentration of salts or solvents from a suspension containing biological material (Schwartz L., “Diafiltration: A Fast, Efficient Method for Desalting or Buffer Exchange of Biological Samples,” Scientific and Technical Report, Pall Life Sciences (2003), which is hereby incorporated by reference in its entirety). According to the present invention, yield of the target species in a diafiltration experiment is estimated after N_{d} diavolumes as follows: yield=1−exp(−N_{d}S_{oaverage}). S_{oaverage} is average observed sieving coefficient during diafiltration (−). Sₒ=S_{d}/((1−S_{α})exp(−J/k)+S_{α} ). Actual sieving coefficient S_{α} is obtained from S_{α}=(S_{∝}exp(Peₘ))/(S_{∝}+exp(Peₘ)−1), wall Peclet number, Peₘ, is obtained from Peₘ=(Jδₘ/D)(S_{∝}/εφK_{d}), Sₘ is taken as the side of the face centered cube of the particles of radius aᵢ that forms the controlling cake for transmission, where δₘ=α=αᵢ [(4(4/3)π)/φᵢₙₜₑᵣₛₜᵢᵥₑ]^{1/3}; intrinsic sieving coefficient S_{∝} is obtained from S_{∝}=(1−λ)²[2−(1−λ)²]exp(−0.7146λ²), where λ=rₛ/rₘᵢₙ, φK_{d}=(1−λ)^{9/2}, rₘᵢₙ is minimum equivalent cake void radius for all cake types (m), rₛ is solute radius (m), and λ is the ratio of solute to pore radii (rₛ/rₘᵢₙ)(−).

By carrying out the steps described above the pressure independent permeation flux and the yield of the target species are thus determined for a permeate resulting from crossflow membrane filtration of particles of any poly-disperse suspension.

Once the predicted permeation flux and target yield are determined according to the present invention as described above, the performance of the filtration system as to permeation flux and yield can be refined using the information acquired by carrying out the above determinations. Thus, the present invention further involves re-calculating the packing density at the membrane wall determinations for all particles in the suspension and determining if the packing constraints are met for all particles. If packing constraints are not met, the estimations made earlier require some correction. Packing density of a particle is corrected by using φ_{wicorrected}=φ_{M}[(φ_{wi})/Σφ_{wi}]. The predicted permeation flux, J, is then reevaluated for the particle selected as having the minimum permeation flux based on φ_{wicorrected}=φₘ[(φ_{wi})/Σ φ_{wi}]. The maximum back-transport velocity (uᵢ), determined as described above, is also reevaluated, and the maximum aggregate packing volume fraction for all particles (φ_{M}) at the membrane wall is re-estimated.

The present invention also involves refining the determination of the yield of the target species. Refining the yield involves determining whether the suspension has a low, intermediate, or high operating shear rate (Sₒ). A suspension is considered to have a low operating shear rate when Sₒ≧0.75, corresponding to a yield ≧0.95, an intermediate operating shear rate when 0<Sₒ≧0.75, corresponding to yield range of from 0 to 95%, and a high operating shear rate when Sₒ≅0. The calculation for Sₒ is carried out using Sₒ=S_{α}/((1−S_{α})exp(−J/k)+Sₐ) The actual sieving coefficient S_{α} is obtained from S_{α}=(S_{∝}exp(Peₘ))/(S_{∝}+exp(Peₘ)−1), the maximum back-transport velocity is (uᵢ)(obtained as described above), the wall Peclet number, Peₘ is obtained from Peₘ=(Jδₘ/D)(S_{∝}/εφK_{d}), δₘ is taken as the side of the face centered cube of the particles of radius αᵢ that forms the controlling cake for transmission, δₘ=α=αᵢ [(4(4/3)π)/φ_{iinterstice}]^{1/3}, the intrinsic sieving coefficient S_{∝} is obtained from S_{∝}=(1−λ)²[2−(1−λ)²]exp(−0.7146λ²), λ=rₛ/rₘᵢₙ, where λ is a ratio of solute to pore radii (rₛ/rₘᵢₙ)(−), rₘᵢₙ is a mirnimum equivalent cake void radius for all cake types (m), rₛ is solute radius (m), and φ K_{d}=(1−λ)^{9/2}, where φ is the equilibrium partition coefficient between membrane pore and suspension (−), and K_{d} is the hindrance factor for diffusive transport (−).

When an intermediate operating shear rate is determined, the value of (J) is refined by calculating the stagnant film flux (J) equation for non-retentive membranes, where J=k ln [(φ_{wi}−φₚₑᵣₘₑₐₜₑᵢ)/(φ_{bi}−φₚₑᵣₘₑₐₜₑᵢ)]≅ln [φ_{wi}/φ_{bi}(1−Sₒ)], wherein (φ_{wi}>>φₚₑᵣₘₑₐₜₑᵢ). Sₒ is then corrected by replacing J=solvent permeation flux (m/s) with the stagnant film flux (J) equation for non-retentive membranes in the equation for observing sieving coefficient, Sₒ, where Sₒ=S_{α}/((1−S_{α})exp(−J/k)+S_{α}).

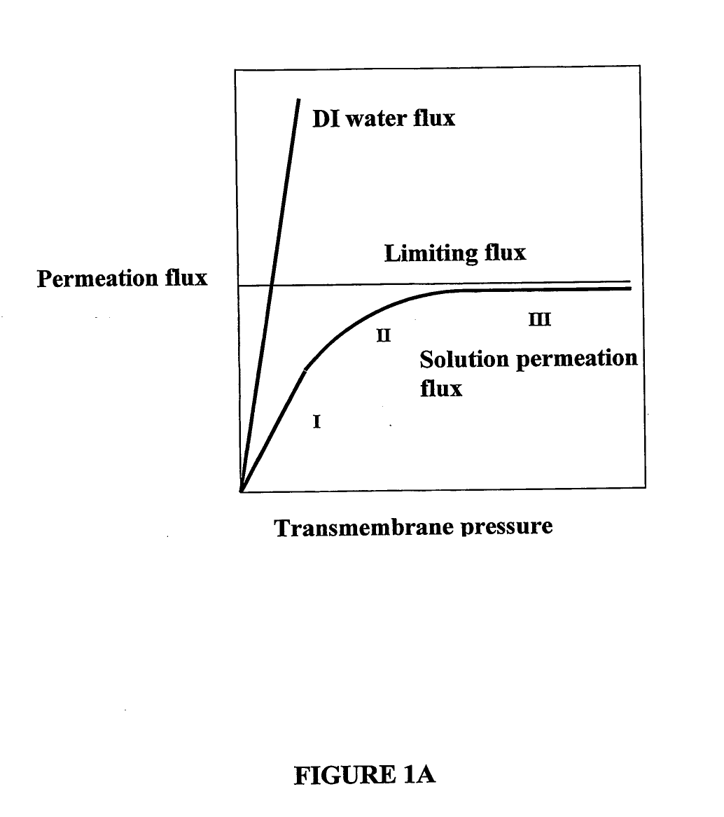

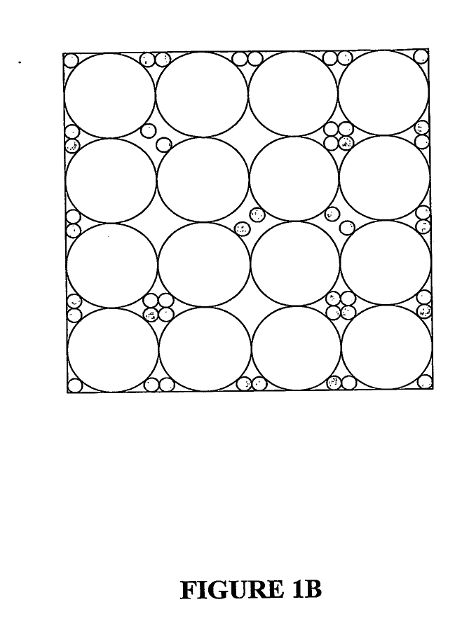

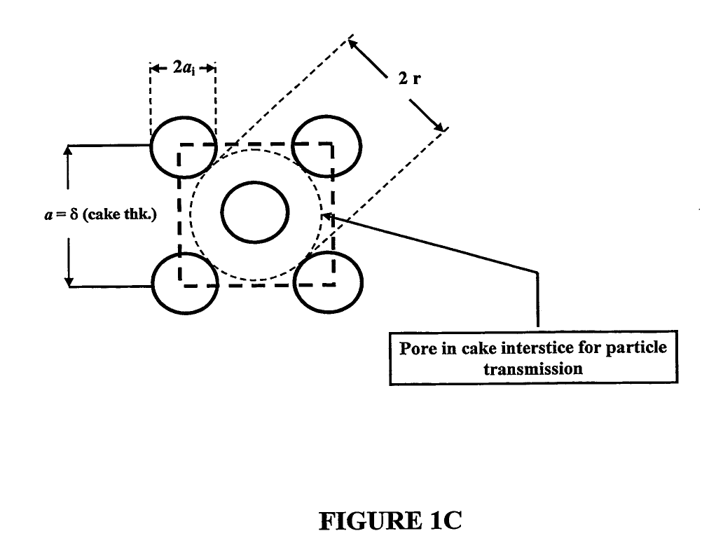

The present invention also involves constructing a plot of the predicted permeation flux and yield versus wall shear rate, such as shown in FIG. 1A.

Filtration can involve microfiltration and ultrafiltration and may be carried out with a flat sheet filter, a hollow-fiber filter, or a helical filter. Suitable suspensions in all aspects of the present invention include, without limitation, waste water, surface water, environmental pollutants, industrial waste streams, industrial feed streams, and streams from biomedical and bio-processing industries. Such streams may contain, without limitation, proteins, cells, nucleic acids, colloids, milk, and suspended particles, in any combination.

The present invention also provides a method for determining the packing density of particles of a poly-disperse suspension at a membrane wall. This method involves providing a predicted permeation flux (J), determining the packing density at a membrane wall for all particle sizes at the predicted permeation flux, and determining the interstitial packing density (φ_{wiinterstice}) of particles in the suspension which are smallest, thereby determining the packing density at membrane wall of the particles of the poly-disperse suspension.

Another aspect of the present invention is a method for predicting pressure independent permeation flux for crossflow membrane filtration of a poly-disperse suspension. This method involves determining viscosity of the suspension, determining the maximum back-transport velocity (uᵢ) for all particles, and estimating the maximum aggregate packing volume fraction (φ_{M}) for all particles at a wall of the filtration membrane wall from geometric considerations. The particle is selected that gives a minimum permeation flux at a given filtration membrane shear rate, where the selected particle has a radius (αᵢ). A predicted permeation flux (j) is determined, and the packing density (φ_{wj}) at the membrane wall for all particle sizes at the permeation flux (αⱼ for j≠i) at the predicted permeation flux is determined. In this aspect of the present invention the determinations of viscosity of the suspension, maximum back-transport velocity, and maximum aggregate packing volume fraction at the membrane wall (φ_{M}) for all particles are carried out using the equations given above for these factors. The minimum permeation flux value is selected by determining a Jₘₐₓ value, as described above, for each particle type in the suspension, then selecting from all the Jₘₐₓ values that Jₘₐₓ having the lowest value. This method may be refined by also carrying out a recalculation of the packing density at the membrane wall determination for all particle sizes, determining if packing constraints are met, and correcting for packing density if packing constraints are not met. The determinations of whether packing constraints are met or not met, and the calculations for correction of packing density are as described herein above.

Another aspect of the present invention is a method for calculating yield of a target molecule in a permeate for a poly-disperse suspension during crossflow membrane filtration. This method involves determining minimum pore diameter (2rₘᵢₙᵢₘᵤₘ) based on the packing density of each particle, and estimating yield of a target species in the filtration permeate by calculating observed sieving coefficient (Sₒ) for the target species. Determination of the minimum pore diameter (2rₘᵢₙᵢₘᵤₘ) is carried out as described above. The determination of minimum pore diameter (2rₘᵢₙᵢₘᵤₘ) is then used to estimate the yield of a desired target molecule in the poly-disperse suspension by carrying out the calculation for the observed sieving coefficient (Sₒ), as described above. This aspect of the present invention may further involve diafiltration. The yield of the target species on a diafiltration experiment can be estimated after N_{d} diavolumes, as described above.

The present invention also relates to a method for designing a crossflow membrane filtration system for a poly-disperse suspension. The performance parameters of a crossflow membrane filtration system can be designed for any selected poly-disperse suspension by applying the methods described herein for predicting pressure independent permeation flux and determining target molecule yield. This involves determining the particle size distribution of the poly-disperse suspension and the equivalent spherical radii of the particles, and determining the viscosity of the suspension and the maximum back-transport velocity (uᵢ) for all particles. It also involves estimating the maximum aggregate packing volume fraction (φₘ) for all particles at the filtration membrane from geometric considerations; selecting the particle that gives a minimum permeation flux at a given filtration membrane shear rate, where the selected particle has a radius (αᵢ), and determining a predicted permeation flux. The method also involves determining packing density at the membrane wall for all particle sizes at the predicted permeation flux, interstitial packing density (φ_{wiinterstice}) of particles in the suspension which are smallest, and minimum pore diameter (2rₘᵢₙᵢₘᵤₘ) based on the packing density at the membrane wall of each particle. The yield of a target species in the permeate is then estimated by calculating observed sieving coefficient (Sₒ) for the target species. All of these determinations are carried out as described above for other aspects of the present invention. Conditions for filtration based on the prediction of permeation flux and target molecule yield are then optimized to design a filtration system for the selected poly-disperse suspension.

Yet another aspect of the present invention is a method of selecting operating conditions of a crossflow filtration system for poly-disperse suspensions. This method involves predicting the pressure independent permeation flux and target molecule yield in a permeate resulting from crossflow membrane filtration of particles in a poly-disperse suspension as described in detail above. This predicts permeation flux (process time) and target molecule yield of the poly-disperse suspension during crossflow membrane filtration. Operating conditions of the system are selected using the determination of limiting pressure independent permeation flux for a given shear rate to obtain an optimal balance between permeation flux and yield of a target species.

The present invention also relates to a method of modeling a process for filtration of a poly-disperse suspension. This method involves applying the method for predicting pressure independent permeation flux and target molecule yield in a permeate resulting from crossflow membrane filtration of particles in a poly-disperse suspension, using the calculations described above, and using a computer-generated program to model the process for filtration of a poly-disperse suspension.

### EXAMPLES

### Example 1

### Aggregate, Transport Model

With the framework described above, the aggregate transport model of the present invention is summarized below. Refer to Table 2 for a definition of symbols used herein.

Step 1. Determine the particle size distribution of the feed suspension and evaluate the equivalent spherical radii. This can be obtained from literature, by size exclusion chromatography or by membrane fractionation.

Step 2. Evaluate the viscosity of the suspension by experiment or estimate it using the modified Einstein-Smoluchowski equation (1)
η/η₀=1+2.5φ_{b}+k₁φ_{b}² (6)

Step 3. Evaluate the maximum back-transport velocity, uᵢ, for a particle based on Brownian diffusion, shear induced diffusion, and inertial lift at the proposed operating wall shear rate assuming full retention for all solutes, using
uᵢ=Max[B(αᵢ, γ, φ_{b}, φ_{w}, L, η), S(αᵢ, γ, φ_{b}, φ_{w}, L, η), I(αᵢ, γ, φ_{b}, φ_{w}, L, η)] (7)
where B, S, and I denote the finctionalities for Brownian diffusion, shear induced diffusion and inertial lift models, respectively, shown in Table 1, above. It is suitable to set φ_{w}=0.64 for each species for the first iteration (Dodds, “The Porosity and Contact Points in Multicomponent Random Sphere Packings Calculated by a Simple Statistical Geometric Model,” J. Colloid Interface 77:317-327 (1980), which is hereby incorporated by reference in its entirety).

Step 4. Estimate the maximum aggregate packing volume fraction for all particles, φ_{M} at the wall, from geometric considerations. For the poly disperse case, this could be much larger than the widely used value 0.64 depending on the size ratios of the particles. If the size ratio is more than 10, the small particles behave as a continuous fluid with respect to the large particles and can migrate into the interstices easily (Farris, “Prediction of the Viscosity of Multimodal Suspensions from Unimodal Viscosity Data,” Trans. Soc. Rheol. 12:281-301 (1968); Probstein et al., “Bimodal Model of Concentrated Suspension Viscosity for Distributed Particle Sizes,” J. Rheol. 38:811-829 (1994); Gondret et al., “Dynamic Viscosity of Macroscopic Suspensions of Bimodal Sized Solid Spheres,” J. Rheol. 41:1261-1274 (1997), which are hereby incorporated by reference in their entirety). For example, for a poly-disperse mixture comprising particles of three sizes such that α₁>10α₂>100 α₃ the relation (8) may be used
φ_{M}=φₘ+φₘ(1−φₘ)+0.74[1−{φₘ+φₘ(1−φₘ)}] (8)
where φₘ is the maximum packing volume fraction for monodisperse spheres=0.64 (36). In this special case, φ_{M}=0.96.

Step 5. Repeat step 1 for all particle sizes and select the particle that gives the minimum permeation flux at the given wall shear rate. The corresponding permeation flux is the predicted one,
J=Min [u, u₂,. . .uₙ]. The selected particle has a radius αᵢ (9)

Step 6. Evaluate packing density for other particle sizes (αⱼ for j≠i) at this permeation flux. Calculate φ_{wj} from the equation
J×Max[B(αⱼ, γ, φ_{b}, φ_{wj}, L, η), S(αⱼ, γ, φ_{b}, φ_{wj}, L, η), I(αj, γ, φ_{b}, φ_{wj}, L, η)] (10)
for all j≠i, using the equations for J shown in Table 1. For particles whose back transport is governed by inertial lift [Table 1, equation (3)], the wall concentration cannot be calculated explicitly by equation (10), but can be estimated by using mass balance and the propensity to lift off. For example, if there is only one such particle type, jI, check if u_{jI}≧10J. If yes, set φ_{wjI}=0 as the particle back-transport velocity is much higher than the polydisperse permeation flux and will be readily lifted off from the membrane wall. If u_{jI} is <10J where one particle type is governed by inertial lift, then φ_{wjI} is calculated by
φ_{wjI}=φ_{M}−Σφ_{wj} (11)
where j≠jI. If there is more than one particle type whose back-transport is governed by inertial lift, jI1 and jI2, their contributions to the cake at the wall can be approximately apportioned in the direct ratio of their volume fractions in the bulk solution and inverse ratio of their back-transport by
φ_{wjI1}+φ_{wjI2}=φ_{M}−Σφ_{wj} (12)
φ_{wjI1}:φ_{wjI2}=φ_{ujI1}uⱼᵢ₂:100 _{bjI2}u_{jI1} (13)
where j≠jI1 or jI2 and u_{jI1}, u_{jI2}<10J.
This logic can be extended for more than two particle types whose back transport is governed by inertial lif

Step 7. Check Σφ_{wi}≦φ_{M} and other packing constraints. These depend on the particle sizes in the cake and have to be developed specifically for each case. In Example 1, below, a typical case of a tridisperse suspension with two large and one small particle type is illustrated. The packing constraints for this case are depicted in FIG. 1C. Guidelines for developing packing constraints are described in Example 3, below. If packing constraints are satisfied, go to Step 8, or else use
φ_{wicorrected}=φ_{M}[(φ_{wi})/Σφ_{wi}] (14)
For the particle selected in Step 5, re-evaluate J based on φ_{wicorrected} instead of 0.64 by repeating Steps 3 and 5.

Step 8. Evaluate interstitial packing density, φ_{wiinterstice} of the smallest particle by
φ_{iinterstice=φ}_{wicorrected}/(1−Σφ_{wjcorrected}) (15)

Step 9. Based on the corrected packing density of each particle, estimate the rnunimum pore diameter 2rₘᵢₙᵢₘᵤₘ from geometric considerations
2rₘᵢₙᵢₘᵤₘ=αᵢ{√2[4(4/3)π/φ_{wiinterstice}]1/3−2} (16)
This is based on a face centered cubic packing for the cake where there are four spherical particles per cube. Here it is assumed that the gap available for transmission in a face centered cubic cake is 2rₘᵢₙᵢₘᵤₘ=α√2−2αᵢ where α is the side of the cube and αᵢ is the radius of the particles located at the vertices and face centers of the cube. a is evaluated based on the value of aᵢ and φ_{wiinterstice}. If this gap is greater than 2rₛ, a particle of radius rs can be transmitted through the cube by displacing two particles located at face centerₛ on the way. Please refer to Example 2 and FIG. 1C for further details.

Step 10. Estimate the yield of target species (with equivalent radius=rₛ) in the permeate by calculating the observed sieving coefficient, So (30).
Sₒ=S_{α}/((1−S_{α})exp(−J/k)+S_{α}) (17)
where actual sieving coefficient S_{α} is obtained from (30)
S_{α}=(S_{∝} exp(Peₘ))/(S_{∝}+exp(Peₘ) -1). (18)
The wall Peclet number, Peₘ is obtained from
Peₘ=(Jδₘ/D)(S_{∝}/εφK_{d}) (19)
where δₘ is taken as the side of the face centered cube of the particles of radius ai that forms the controlling cake for transmission. In general, the governing case for flux and product transmission (corresponding to rₘᵢₙᵢₘᵤₘ) may be different. Hence,
δₘ=α=αᵢ[(4(4/3)π)/φ_{iinterstice}]^{1/3} (20)
The intrinsic sieving coefficient S_{∝} is obtained from (40)
S_{∝}=(1−λ)[2−(1−λ)²]exp(−0.7146λ²) (21)
where λ=rₛ/rₘᵢₙᵢₘᵤₘ, φK_{d} is estimated from (41)
φK_{d}=(1−λ)^{9/2} (22)

The yield of the target species in a diafiltration experiment can be evaluated after N_{d} diavolumes by using the following relation (30)
Yield=1−exp(−N_{d}S_{oaverage}) (23)
Step 11. There are three possible scenarios corresponding to low, intermediate and high operating shear rates. For low operating shear rates, the cake will be dominated by the larger particles leading to high observed sieving coefficients where Sₒ≧0.75, corresponding to Yield≧0.95 according to equation (20) for 4 diavolumes. For such cases no finther refinement is needed. For intermediate operating shear rates, 0<Sₒ<0.75, leading to a yield range from 0 to 95%. For this case, Sₒ is further corrected by using the stagnant film flux equation for non-retentive membranes (for φ_{wi}>>φₚₑᵣₘₑₐₜₑᵢ).
J=k ln[(φ_{wi}−φₚₑᵣₘₑₐₜₑᵢ)/(φ_{bi}−φₚₑᵣₘₑₐₜₑᵢ)]≅k ln [φ_{wi}/φ_{bi}(1−Sₒ)] (24)
for the transmitted species in Step 3. Steps 3 to 10 are repeated until the values of Sₒ obtained by equations (14) and (20) are within 10% of each other. For high operating shear rates, the cake is dominated by the smallest particles and Sₒ≅0 implying no transmission of the smallest particles. Thus, in this case, the original assumption of fall retention is valid and no fiiter iterations are required.

Step 12. Construct plot of predicted permeation flux and yield versus wall shear rate for the pressure-independent regime.

TABLE 2

| Symbol | Refers To: |
|---|---|
| a | Radius of species (m) |
| D | Molecular diffusion coefficient (m²/s) |
| J | Solvent permeation flux (m/s) |
| k | Mass transfer coefficient (m/s) |
| k₁ | Shape factor (-) |
| K_{d} | Hindrance factor for diffusive transport (-) |
| L | Tube length, (m) |
| ln | Natural log |
| N_{d} | Number of diavolumes during diafiltration (-) |
| Peₘ | Membrane Peclet number (-) |
| rᵢ | Equivalent cake void radius (m) |
| rₘᵢₙ | Minimum equivalent cake void radius for all cake types (m) |
| rₛ | Solute radius (m) |
| Sₒ | Observed sieving coefficient (-) |
| S_{oaverage} | Average observed sieving coefficient during diafiltration (-) |
| Sₐ | Actual sieving coefficient (-) |
| S_{∝} | Asymptotic (intrinsic) sieving coefficient (-) |
| T | Temperature (K) |
| uᵢ | Back diffusion velocity of particle i (m/s) |
| δ | Momentum boundary layer thickness (m) |
| δₘ | Membrane/cake thickness (m) |
| ε | Cake/membrane porosity (-) |
| φ- | Equilibrium partition coefficient between membrane pore |
| | and suspension/solution (-) |
| φ_{b} | Particle volume fraction in the bulk suspension (-) |
| φ_{w} | Particle volume fraction at the membrane wall (-) |
| γ | Wall shear rate (s⁻¹) |
| η- | Bulk fluid viscosity (kg/m · s) |
| η₀- | Bulk fluid viscosity without solute (kg/m · s) |
| κ | Boltzmann constant (J/mol K) (1.3807 × 10⁻²³ J K⁻¹) |
| λ- | Ratio of solute to pore radii (rₛ/rₘᵢₙ)(-) |
| ρ- | Particle density (kg/m³) |

### Example 2

### Sample Calculation of Permeation Flux and Yield for a Hypothetical Poly-disperse Suspension

The method of the present invention is first illustrated by applying it to a hypothetical suspension comprising three different sized particles: 10, 180, and 300 nm. The relevant data for the tridisperse suspension and microfiltration system are shown below in Table 3 and the calculations are described step-wise below.

TABLE 3

| | | |
|---|---|---|
| Module length | 0.3 | m |
| Number of fibers | 6 | |
| Fiber I.D. | 1.27 | mm |
| Pore size | 0.1 | μm |
| Temperature | 298 | K |
| Shear rate | 32,400 | sec⁻¹ |
| Particle sizes and bulk | 10 | nm at 1%, |
| concentrations | 180 | nm at 5%, |
| | 300 | nm at 6% by volume |
| Target particle radius | 10 | nm |

Calculations were carried out as follows.

Step 1: Evaluate particle size and equivalent radii. Particle sizes are given above in Table 3.

Steps 2-7: Evaluate the pressure independent permeation flux at the given conditions. This is evaluated iteratively by a spreadsheet program (incorporating Steps 2-7 of the method of the present invention) at the shear rate of 32,400 sec⁻¹. J=30 lmh and the selected particle has a radius=180 nm and φ_{w180nm}=0.435. In this example, there are three different particle radii, 10 nm, 180 nm, and 300 nm. The maximum packing fraction considering the 180 um and 300 nm will be 0.68 (Gondret et al., “Dynamic Viscosity of Macroscopic Suspensions of Bimodal Sized Solid Spheres,” J. Rheol. 41:1261-1274 (1997), which is hereby incorporated by reference in its entirety). The 10 nm particles are less than 1/10th of the next higher size particles and hence, can freely move around the interstices of the bigger particles (Probstein et al., “Bimodal Model of Concentrated Suspension Viscosity for Distributed Particle Sizes,” J. Rheol. 38:811-829 (1994), which is hereby incorporated by reference in its entirety). Assuming that the 10 nm particles can reach a maxiinum packing of 0.74 (corresponding to face centered cubic packing) in the interstices of the bigger particles, the maximum aggregate packing=0.68+0.74(1−0.68)=0.92. This value is used for φ_{M} in steps 4 and 7.

Step 6: Evaluate the packing densities of the other particles. The spreadsheet program based on Step 6 gives φ_{w10nm}=0.27 and φW_{300 nm}=0.179.

Step 8: Evaluate the interstitial packing density of the smallest particle. φ_{w10 nm interstice}=0.27/[1−(0.435+0.179)]=0.7 using equation (12).

Step 9: Evaluate the minimum pore radius for transmission. Using equation (13), rₘᵢₙ=10.38 nm.

Step 10: Estimate the yield of the target species. Using λ=rₛ/rₘᵢₙᵢₘᵤₘ, λ=0.963. Using equations (18) and (19), S_{∝}=0.001382 and φK_{d}=3.446E-7, where Peₘ=(Jδₘ/D)(S_{∝}/εφK_{d})(16). Cake thickness, δₘ=28.8 nm using equation (20), ε=1−φ_{w10 nm interstice}=0.3. Next, D is estimated. Using Einstein's equation, D=(κT)/(6πηαᵢ)=1.67×10⁻¹¹ m²/sec. Using the value of J calculated earlier, Peₘ=384. Using equation (16) and (17), S_{α}=0.00138 and Sₒ=0.088. Finally, using equation (20) for S_{oaverage}=0.088 and for a diafiltration run after 4 diavolumes, yield is determined to be 30%. Therefore, for this sample problem, J=30 lmh and Yield=30% for the first iteration.

Step 11: Refine the yield of the target species. Adopting

J=k ln [(φ_{wi}=φₚₑᵣₘₑₐₜₑᵢ)/(φ_{bi}=φₚₑᵣₘₑₐₜₑᵢ)]≅k ln [φ_{wi}/φ_{bi}(1−Sₒ)] (24)

for the 10 nm particles as 0<Sₒ<0.75 Step 9 is executed to obtain, after a few iterations, J=31.5 lmh, φ_{w10 nm}=0.205, φ_{w180 nm}=0.49 and φ_{w300 nm}=0.19. Following the same procedure as for the first iteration, Sₒ=0.37 and after 4 diavolumes for 10 nm particles, assuming S_{oaverage}=0.37 the Yield=77%. Therefore, for this sample problem, J=31.5 lmh and Yield=77%.

On the other hand, if the shear rate was increased to 44,600 sec⁻¹, the pressure-independent permeation flux would have increased to 36 lmh but the yield of the 10 mn radius target species is predicted to be 0! In actual practice, there will be a small finite yield because close to the exit of the module the permeation flux will be less than the pressure-independent permeation flux due to low transmembrane pressure in that region. The model is expected to be more accurate for the uniform transiembrane pressure case or in the case of a stirred cell where the transmembrane pressure is constant.

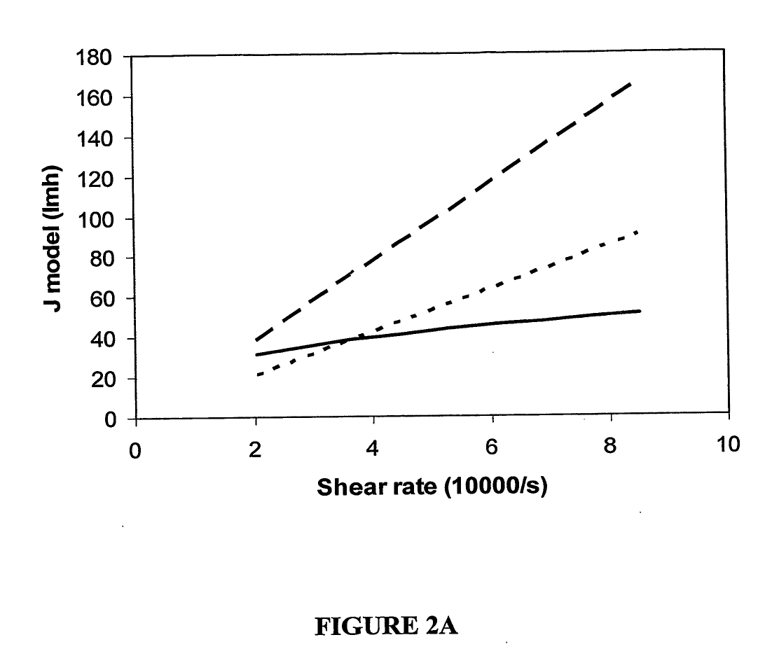

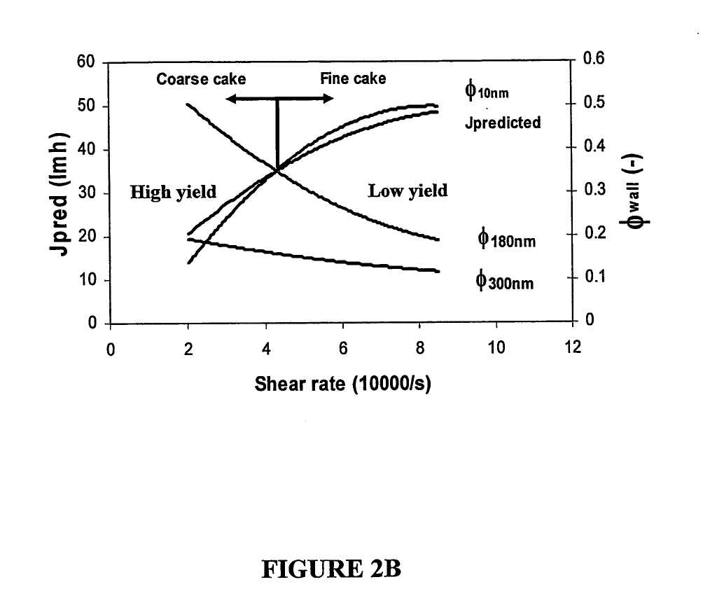

The sample calculations for a hypothetical suspension comprising particles of three sizes indicate three different curves for pressure-independent permeation flux versus shear rate. This is shown in FIG. 2A. As shown in FIG. 2A, at high shear rates the smallest particles have the lowest back-transport velocities. Hence, at high shear rates the poly-disperse flux will be determined by the smallest particles.

The predicted poly-disperse permeation flux and packing densities in the cake for each particle size at different shear rates are derived and plotted as shown in FIG. 2B. It is observed that the packing densities of large 300 and 180 nm particles decrease with increasing shear rate making way for the smallest particle size of 10 nm. The transition from a coarse to fine cake occurs at a shear rate of around 40,000 s⁻¹. Operation at shear rates lower than 40,000 s⁻¹ will lead to higher transmission of 10 nm particles because of the coarse nature of the cake. The converse is expected at shear rates higher than 40,000 s⁻¹. This methodology ignores inter-particle interactions. At low shear rates the packing densities of the larger particles tend to increase. When applying this model to real situations it has to be determined if the preponderance of larger particles in the cake lead to deposits of smaller particles due to adhesion, hydrophobic interaction, etc. If that is the case, the best solution may be to operate at high shear rates but, in the pressure dependent regime, which will lead to a sparse cake of fine particles allowing good transmission of the target particles.

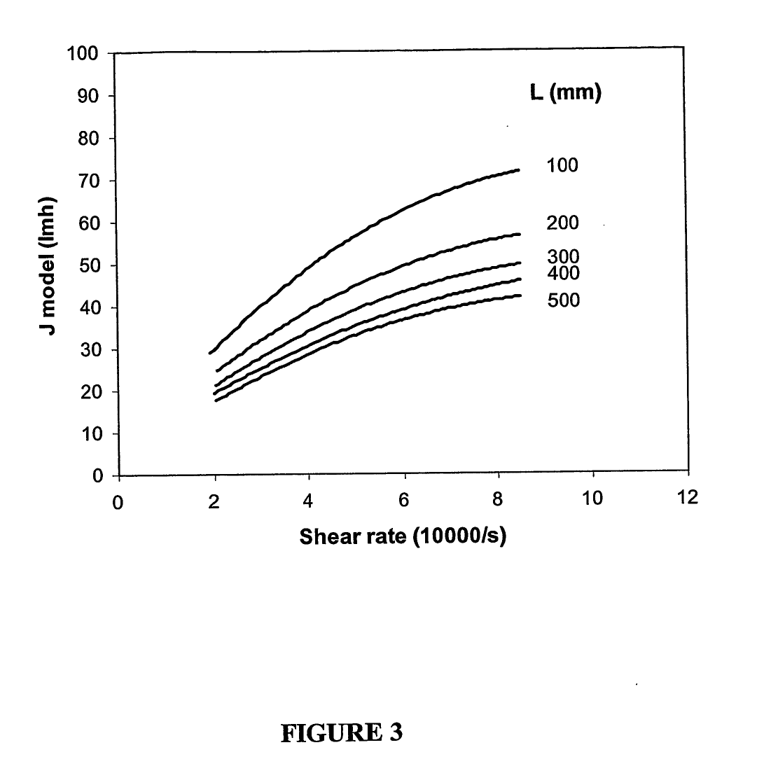

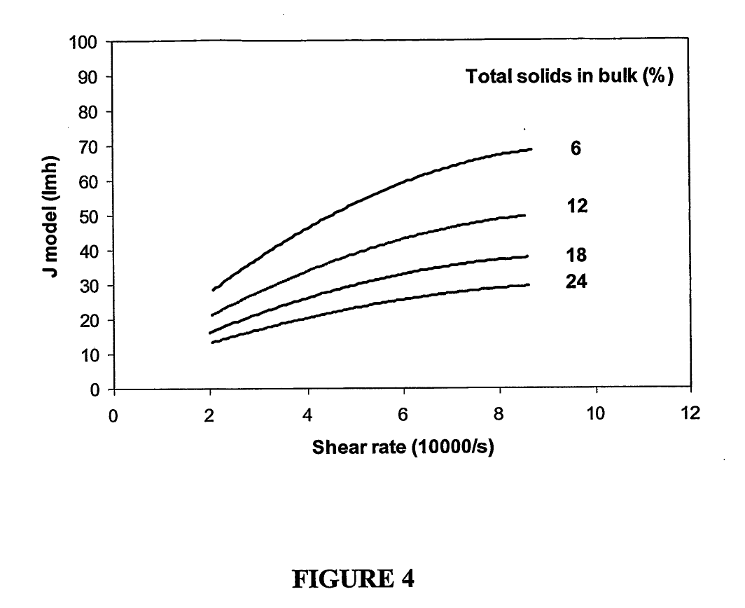

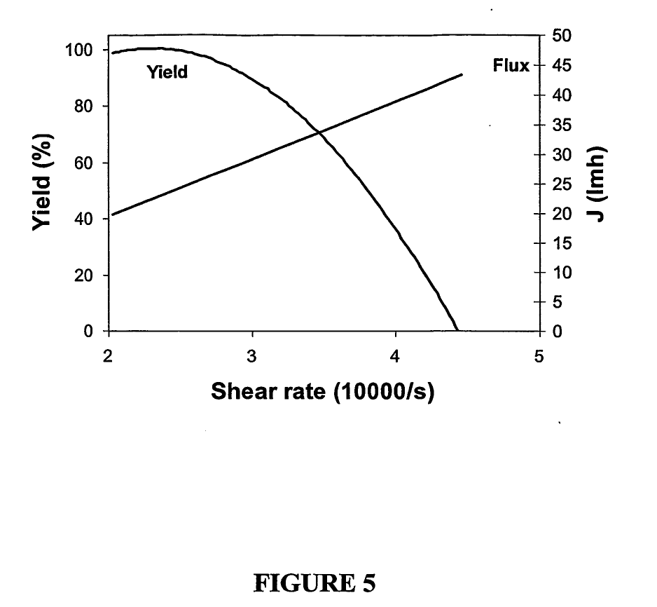

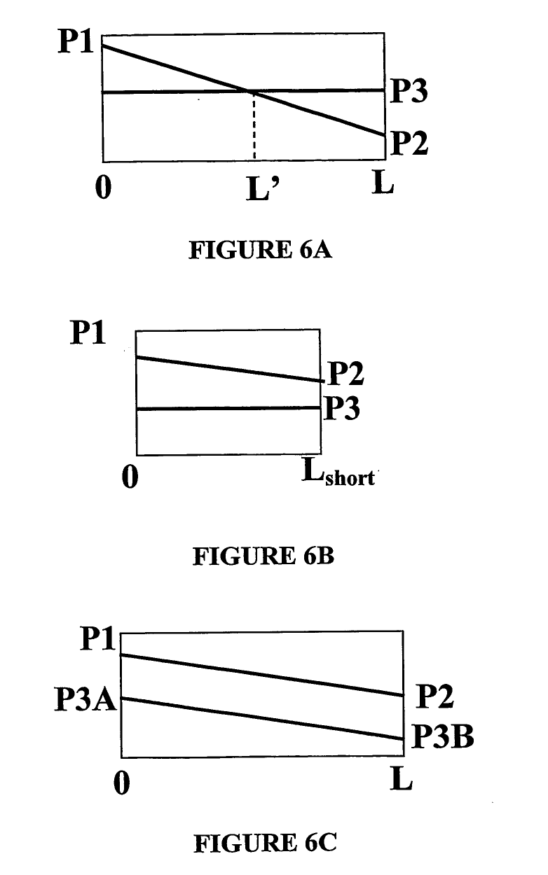

The sensitivity of permeation flux with respect to module length and total solids volume fraction in the bulk suspension is shown in FIG. 3 and FIG. 4, respectively. As expected, the model predicts higher permeation fluxes with shorter module lengths and for feeds of lower bulk concentrations. FIG. 5 depicts the expected yield (defined as the fraction of target molecules originally in the feed that is recovered in the permeate) of the 10 nm radius particles against the wall shear rate in the pressure independent permeation flux regime. The yield is close to 100% until a shear rate of ˜28,000 s⁻¹ is reached. Beyond this value of the shear rate, the yield drops rapidly. This captures the phenomenon reported by several researcherₛ (Berre et al., “Skim Milk Crossflow Microfiltration Performance Versus Permeation Flux to Wall Shear Stress Ratio,” J. Membr. Sci. 117:261-270 (1996); Gesan-Guiziou et al., “Critical Stability Conditions in Crossflow Microfiltration of Skimmed Milk: Transition to Irreversible Deposition,” J. Membr. Sci. 158:211-222 (1999); Gesan-Guiziou et al., “Performance of Whey Crossflow Microfiltration During Transient and Stationary Operating Conditions,” J. Membr. Sci. 104:271-281 (1995); Gesan-Guiziou et al., “Critical Stability Conditions in Skimmed Milk Crossflow Microfiltration: Impact on Operating Modes,” Lait 80:129-140 (2000), which are hereby incorporated by reference in their entirety) of a critical permeation flux to shear rate ratio beyond which protein transmission during microfiltration of milk reduces drastically. Thus, this model can be used to specify the limiting pressure independent permeation flux for a given shear rate and the expected yield of a target protein under these conditions. To obtain good yield, one should operate at much lower permeation fluxes. Depending on the size of the target species, an optimization exercise can be carried out in order to choose a desirable balance between the yield of the target species and the permeation flux. In typical hollow fiber modules, the transmembrane pressure cannot be varied independently of the shear rate because a high shear rate gives rise to a high axial pressure drop and, consequently, a high transmembrane pressure, high permeation flux, and, possibly, a lower yield. This leaves the option of reducing permeation flux as required, by throttling the permeate stream. This, however, leads to inefficient usage of the module as there will be reverse permeation called Starling flow (Hammer et al., “Quantitative Flow Measurements in Bioreactorₛ by Nuclear Magnetic Resonance Inaging,” Bio/Technology 8:327-330 (1990); Heath et al., “Magnetic Resonance Imaging and Modeling of Flow in Hollow-Fiber Bioreactor,” AIChE Journal 36(4):547-558 (1990), which are hereby incorporated by reference in their entirety) at downstream locations in the module where the permeate pressure will exceed the tube pressure. This is depicted in FIG. 6A.

In addition, even at low transmembrane pressures, a compact cake may form near the entrance of the filter due to higher transmembrane pressure and resultant permeation flux in this region. Therefore, good sieving of the target molecule will only be achieved after some distance along the membrane. To alleviate this difficulty, short modules to reduce the axial pressure drop are recommended, as shown in FIG. 6B. Better still, this problem is completely eliminated by using permeate recirculation to maintain uniform transmembrane pressure along the length of the module, as shown in FIG. 6C. In this way, high shear rate operation with low permeation is possible and high yields of target species can be obtained.

Another beneficial mode of operation can be to maintain the wall volume fraction K of the species corresponding to the least void radius, constant as evaluated in step 6 of the method. This will result in a fairly uniform sieving coefficient during diafiltration. To achieve this, the constant φ_{w}, the method recommended by van Reis et al (Reis et al., “Constant C_{wall} Ultrafiltration Process Control,” J. Membr. Sci., 130:123-140 (1997), which is hereby incorporated by reference in its entirety) could be adopted.

### Example 3

### Guidelines for Developing Packing Constraints

Packing constraints of the cake formed at the membrane wall depend on the size distribution of the particles in the bulk suspension. A few aspects have been covered in Steps 4 of the aggregate transport model described above herein, and as shown in FIG. 1C. Further guidelines to evolve packing constraints are presented here.

Step B1. Estimate the maximum aggregate packing volume fraction for all particles. Variants of equation (8) of Step 4 may be used. If the maximum radius ratio of the particles is <10, φ_{M} can be set to 0.68 based on reference (Gondret et al., “[Dynamic Viscosity of Macroscopic Suspensions of Bimodal Sized Solid Spheres, J. Rheol. 41:1261-1274 (1997), which is hereby incorporated by reference in its entirety). If there are two distinct groups of particles separated by a factor of ≧10 in radii, a truncated version of equation (8) may be used
φ_{M}=φₘ+0.74(1−φₘ) (B1)
where φₘ may be set to 0.64 to denote the highest packing volume fraction for a single species. In a manner similar to equations (B) and (B1), φ_{M} for the case for more than three distinct particle size groups can be estimated. The particle composition of the cake and the bulk suspension will be different because of the different back-transport mechanisms applicable for different particle types. It is possible that certain particles get swept away from the wall at very high back-transport rates. These particles can be eliminated from the cake if their back-transport rates are more than 10 times higher than the poly-disperse flux evaluated in Step 5. This will simplify the problem greatly.

Step B2. Evaluate the interstitial packing of the smallest particles. It is assumed that the smallest particles can pack tightly in an FCC structure within the interstices of particles which have radii more than 10 times that of the smallest particles. If there is a range of sizes within the smallest size group, the mean radius may be considered as an approximation. Thus:
φₛₘₐₗₗₑₛₜ≦0.74(1−Σφⱼ) (B2)
φₛₘₐₗₗₑₛₜ≦0.64 (B3)
φ_{smallest interstice}=(φₛₘₐₗₗₑₛₜ)/(1−Σφⱼ) (B4)
where j≠smallest particle.

### Example 4

### Gap Calculations for a Face Centered Cubic Arrangement of Particles

In a face centered cubic arrangement each face center particle is shared by two cubes and each comer particle is shared by eight cubes. Hence, total number of particles per cube=6/2+8/8=4. Let α=side of the cube, αᵢ=radius of the particle and φ_{wiinterstice}=interstitial packing fraction of the particle, then
φ_{wiinterstice}=(4(4/3)παᵢ³ 1α(C1)
After rearrangement,
α=αᵢ[(4(4/3)π)/φ_{wiinterstice}]^{1/3} (C2)
The gap for particle transmission
α√2−2αᵢ=αᵢ{√2[4(4/3)π/φ_{wiinterstice}]^{1/3}−2} (C3)

### Example 5

### Application to a Model for Microfiltration of IgG from Transgenic Goat Milk

The method of the present invention was used to design a predictive aggregate transport model to meet the technical challenge of recovering human IgG fusion protein from transgenic whole goat milk by microfiltration at reasonable cost with high purity and yield. To test the model's predictability of permeate flux and mass transport, a comprehensive series of experiments with varying wall shear rate, feed temperature, feed concentration, and module design are presented herein.

A very good fit was obtained between the model predictions and measurements for a wide variety of experimental conditions. For microfiltration module design comparison, a linear hollow fiber module (representing current commercial technologies) gave lower permeation flux and higher yield than a helical hollow fiber module (representing the latest self-cleaning methodology). These results are easily explained with the model which is now being used to define operating conditions for maximizing performance.

The procedure described by the model is generally applicable and can be used to obtain optimal filtration performance for applications other than milk.

Here, the aggregate transport model of the present invention is tested using whole transgenic goat milk, an enormously complex and challenging fluid, for recovery of a desirable molecule such as a heterologous immunoglobulin (IgG). The transgenic process has evolved recently as an economically attractive way of producing large amounts of human therapeutic proteins (Kreeger, “Transgenic Mammals Likely to Transform Drug Maling,” The Scientist 11(15) 1997); Pollock et al., “Transgenic Milk as a Method For The Production of Recombinant Antibodies,” J. Immunol Methods 231:147-157 (1999); John et al., “Expression of an Engineered Form of Recombinant Procollagen in Mouse Milk,” Nature Biotech. 17: 385-389 (1999); which are hereby incorporated by reference in their entirety). In contrast to the traditional method of using large scale batch cell cultures or blood plasma fractionation, transgenic production involves the creation of genetically altered animals which express the desired protein in their milk. A DNA construct, comprising the sequence that will encode the target human protein and an adjacent promoter sequence which facilitates expression only in the mammary glands, is inserted into a goat cell line by transfection. The nucleus is removed from an oocyte which is extracted from an animal. A transfected, selected transgenic cell is then fused with the enucleated oocyte by electrofusion. After 24-48 hours in culture, the embryo is transferred to a surrogate mother. The putative transgenic animals are identified by screening the offspring for the transgene by PCR and Southern blotting. After the selected females mature, they are bred and the milk produced after gestation is tested for protein expression. The process therefore involves two gestation periods and one maturing period. For goats and cows this period is 16-18 months and 3 years, respectively (Pollock et al., “Transgenic Milk as a Method For The Production of Recombinant Antibodies,” J. Immunol. Methods 231:147-157 (1999), which is. hereby incorporated by reference in its entirety).

Several companies and organizations now use this technology. A plethora of therapeutic proteins such as human monoclonal antibodies, tissue plasminogen activator, antithrombin III, and human lactoferrin are proposed for manufacture by the transgenic process and are in various stages of FDA approval (Kreeger, “Transgenic Mammals Likely to Transform Drug Making,” Tize Scientist 11(15) 1997); Pollock et al., “Transgenic Milk as a Method For The Production of Recombinant Antibodies,” J. Immunol. Methods_{—}231:147-157 (1999); Prunkard et al., “High-Level Expression of Recombinant Human Fibrinogen in the Milk of Transgenic Mice,” Nature Biotech. 14: 867-871 (1996); Mckee et al., “Production of Biologically Active Salmon Calcitonin in the Milk of Transgenic Rabbits,” Nature Biotech. 16:647-651 (1998); John et al., “Expression of an Engineered Form of Recombinant Procollagen in Mouse Milk,” Nature Biotech. 17: 385-389 (1999), which are hereby incorporated by reference in their entirety). Remaining technical challenges include proper post translational modification of the secreted proteins and adequate product recovery from milk.

Although milk from transgenic farm animals can become a large source of therapeutic proteins, the complexity of milk combined with the low concentration of target protein complicates the recovery process. Whole milk consists of more than 100,000 different molecules dispersed in three phases namely, lipid, casein, and whey (Dairy Processing Handbook, Tetra Pak Processing Systems, AB, S-221 86, Lund Sweden, (1995), which is hereby incorporated by reference in its entirety). The composition and properties of the main constituents in goat milk are given below in Table 4. Essentially, goat milk consists of 4 wt. % each of protein, fat, and low molecular weight moieties like carbohydrates, sugars, and salts. About 80% of the proteins exist in the form of casein micelles. Heterologous recombinant proteins can be overproduced in the range of 0.2 to 1 wt. %. The first step in isolating heterologous proteins from transgenic milk involves the removal of casein micelles and fat globules from the milk leaving behind low molecular weight salts and sugars. The traditional methods used by the dairy industry to isolate proteins from milk include pasteurization followed by enzymatic coagulation or acid precipitation at pH 4.6 (pI of casein). These steps are often unsuitable for the recovery of heterologous proteins, because they can be temperature and pH sensitive. Additionally, the coagulation process traps most of the target protein within casein pellets resulting in poor yields (Morcol et al., “Model Process for Removal of Caseins from Milk of Transgenic Animals,” Biotechnol. Prog. 17:577-582 (2001), which is hereby incorporated by reference in its entirety). The removal of fat is another important issue. There are inherent difficulties with centrifugation regarding scale-up and contamination. Milk is skimmed industrially at a centrifugal force of 500 g. Fat globules smaller than 5 μm escape this process. Sub-micron size fat globules can be removed by ultracentrifugation (600,00 g), but this is only practical for small volumes (Gardner et al., “Delipidation Treatments for Large Scale Protein Purification Processing,” Master's thesis at Virginia Polytechnic Institute and State University (1998), which is hereby incorporated by reference in its entirety). Instead, microfiltration can be used for the removal of casein and fat (retained in the retentate) with the target protein passing with the permeate (Pollock et al., “Transgenic Milk as a Method For The Production of Recombinant Antibodies,” J Immunol. Methods 231:147-157 (1999); Meade et al., Gene Expression Systems: Using Nature for the Art of Expression, Academic Press. pp. 399-427 (1999); which are hereby incorporated by reference in their entirety). Thus, microfiltration followed by ultrafiltration with various chromatographic steps becomes an attractive method for transgenic milk processing. Many of these processes have been patented for similar applications (U.S. Pat. No. 5,756,687 to Denman et al.; U.S. Pat. No. 6,183,803 to Morcol et al., which are hereby incorporated by reference in their entirety). Transgenic milk is neither pasteurized nor homogenized in order to prevent damage and loss of the target heterologous proteins. Fat globules and casein micelles are the putative foulants for whole milk microfiltration, because the other moieties are much smaller than the average pore size of the 0.1 μm microfiltration membrane, they easily pass through the membrane with the permeate.

Most of the lipids (>95%) in milk exist in the form of globules ranging from 0.1 to 20 μm in diameter (Goffet al., “Dairy Chemistry and Physics,” in Dairy Science and Technology Handbook, Vol. 1, Principles and Properties, Hui, Y. H. ed., New York:VCH Publishers, Chap. 1, pp. 1-81 (1993), which is hereby incorporated by reference in its entirety). In non-homogenized milk, the liquid fat droplets are encased by a 8 to 10 nm thick membrane called the native fat globule membrane (FGM). This is comprised of apical plasma membrane of the secretory cell which continually envelopes the fat droplets as they pass into the lumen of the mammary gland. The FGM is therefore, composed of phospholipids and proteins and is characterized by a very low interfacial surface tension, 1 to 2.5 mN/m, between the fat globules and the serum phase. This prevents the globules from flocculating and from enzymatic degradation. Homogenization decreases the diameter of the fat globules, thereby significantly increasing the surface area of the fat globules resulting in insufficient native FGM to cover all the fat globules. On disruption of the native FGM, the interfacial surface tension increases to a value of ˜15 mN/m allowing serum proteins and casein micelles freely to adsorb onto the exposed fat globules. Thus, homogenization leads to a reduction in the size of fat globules as well as loss of proteins through adsorption (Meade et al., “Gene Expression Systems: Using Nature for the Art of Expression,” Academic Press. pp. 399-427 (1999), which is hereby incorporated by reference in its entirety). The latter effect is expected to reduce the yield of target protein and the former effect increases membrane fouling because of a lower value of back-transport due to shear or inertial lift. Thus, the large fat globules in non-homogenized whole milk may not be the chief foulant in whole milk microfiltration. This hypothesis is tested herein.

There is considerable dispute as to the exact nature of the casein micelle. The present consensus is that the casein micelle is a roughly spherical, fairly swollen particle of 0.1 to 0.3 μm diameter with a hairy outer layer (Walstra, “Casein Sub-Micelle: Do They Exist? Int. Dairy J. 9:189-192 (1999), which is hereby incorporated by reference in its entirety). This is supported by electron microscopy studies (McMahon et al., “Rethiking Casein Micelle Structure Using Electron Microscopy,” J. Dairy Sci. 81:2985-2993 (1998), which is hereby incorporated by reference in its entirety). The hairy layer is comprised of C-terminal ends of ic-casein. This prevents further aggregation of micelles and flocculation by steric and electrostatic repulsion at pH values higher than 4.6, the pI of casein. Thus, at the physiological pH of milk, i.e., 6.4-6.6, the casein micelles predominantly exist as distinct particles of a size range comparable to the mean pore size (0.1 μm) of the poly(ether sulfone) microfiltration membrane. This is expected to result in a low shear-induced diffusion coefficient as well as fouling by pore blockage, cake formation, and pore constriction for larger pores. It is thus expected that for this case, the casein micelles are the main candidates for pore plugging and cake formation (fouling). This is corroborated by polyacrylamide gel electrophoresis studies of permeate samples of milk clarified by microfiltration with a 0.2 μm average pore size ceramic membrane which indicate negligible casein transmission through the membrane.

Here, crossflow microfiltration of raw goat milk is carried out, the first step in the protein recovery process from transgenic whole goat milk. A working predictive model for describing the rather complex process of transgenic whole milk microfiltration has been developed applying the method of the present invention. The next steρ is to develop an optimizing strategy for diafiltration using this model and then to conduct diafiltration experiments as a validation. In this study experiments were undertaken for both linear and helical hollow fiber modules (Luque et al., “A New Coiled Hollow-Fiber Module Design for Enhanced Microfiltration Performance in Biotechnology,” Biotechnol. Bioeng. 65:247-257 (1999), which is hereby incorporated by reference in its entirety). It is well known that the main problems in milk microfiltration are low flux and poor protein transmission due to concentration polarization and fouling. High crossflow velocity, back pulsing, pulsatile flow, and Taylor and Dean vortices represent some of the techniques used by researcherₛ to mitigate this problem (13elfort et al., “The Behavior of Suspensions and Macromolecular Solutions in Crossflow Microfiltration,” J. Membr. Sci. 96:1-58 (1994), which is hereby incorporated by reference in its entirety). The performance of a traditional linear hollow fiber module is compared with the Dean vortex helical hollow fiber module (U.S. Pat. No. RE 37,759 to Belfort, which is hereby incorporated by reference in its entirety).

### Example 6

### The Aggregate Transport Model for Poly-Disperse Suspensions

As described above, the goal of the model provided by the present invention is to predict the performance of microfiltration of poly-disperse suspensions in terms of permeation flux and yield of a target species. The simplifying assumptions in this model are laminar flow, absence of inter-particle and particle-to-membrane interactions. The first steρ is to establish the particle size distribution of the suspension. Existing back-diffusion and inertial lift laws are then employed to calculate the hypothetical mono-disperse permeation fluxes for each particle size and concentration (]3elfort et al., “The Behavior of Suspensions and Macromolecular Solutions in Crossflow Microfiltration,” J. Membr. Sci. 96:1-58 (1994), which is hereby incorporated by reference in its entirety). The lowest of these permeation fluxes is then considered the determining flux of the poly-disperse suspension. This permeation flux is then used in the back-transport laws to calculate the concentration of each species in the filter cake. Essentially, this is the equilibrium concentration at the membrane wall that can ensure a balance between forward and back-transport of each species from the membrane. The evaluated packing densities of various particles are then tested with respect to packing constraints that limit the cake depending on the particle sizes. If the packing constraints are not satisfied, the highest packing density is lowered and the steps executed once again. This is repeated until all the packing constraints are satisfied. Thus, the nature of the filter cake is evaluated. The interstitial gap between the particles is estimated and steric arguments are used to estimate the yield of the target species (Zeman et al., “Microfiltration and Ultrafiltration Principles and Applications,” New York: Marcel Dekker, Inc. (1996), which is hereby incorporated by reference in its entirety). If the yield of the target particle is between 0 and 0.94 for four diavolumes, the non-retentive stagnant film model is employed for the transmitted species and all the steps are repeated to evaluate the corrected flux and yield.

### Example 7

### Microfditration Characterization With Transgenic Goat Milk

Transgenic goat milk to be used as feed suspension was supplied by GTC Biotherapeutics (Charlton, MA). The average composition of the transgenic goat milk is shown in Table 4, below (Dairy Processing Handbook. Tetra Pak Processing Systems, AB, S-221 86, Lund Sweden, (1995), which is hereby incorporated by reference in its entirety). The human IgG concentration in the transgenic goat milk (˜8 gll) was diluted with non-transgenic milk to between 1.75 to 3 g/l.

TABLE 4

| | | Main Component |
|---|---|---|
| Composition (wt. %) | Salient Properties | Diameters |
| Fat: 3.5% | pH: 6.6-6.9 | Fat: 1 to 20 μm |
| Proteins: 3.1% (80% | Human IgG pI: 5.5-6.5 | Casein micelles: |
| casein, rest | Casein pI: 4.6 | 0.3-0.4 μm |
| α-lactalbumin, | | |
| β-lactoglobulin, | | |
| Immunoglobulins) | | IgG: 20 nm (155 kDa) |
| Lactose: 4.6% | | Other whey proteins: |
| Ash: 0.8% | | 15-40 kDa |
| Human IgG: 2 to 3 g/l | | |
| Total solids: 12%. | | |

### Example 8

### Membrane Modules

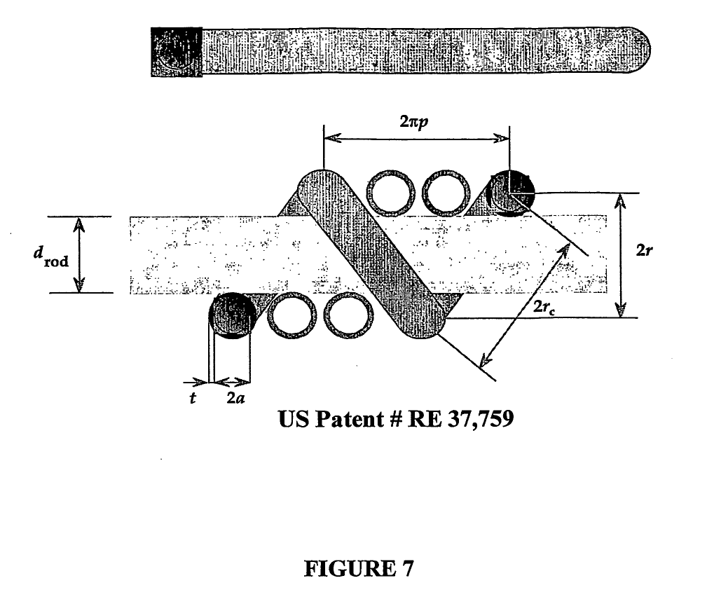

Tubular hollow fiber membrane modules were provided by Mllipore Corporation (Bedford, Mass.). Each module had six 0.1 μm mean pore-size poly(ether sulfone) hollow fibers. For the helical module, the fiberₛ were wound in a single-wrap helix around an acrylic rod as shown in FIG. 7 (U.S. Pat. No. RE 37,759 to Belfort, which is hereby incorporated by reference in its entirety). The purpose of the rod is to stabilize the membrane helix and establish the desired curvature (α/r_{c}). Table 5 summarizes the design specifications and operation parameterₛ for the helical and linear hollow fiber modules.

TABLE 5

| Set | Model | Aₘ^{a} | L^{b} | Lp^{e} |
|---|---|---|---|---|
| Linear | | | | |
| L-1 | 110698-1 | 153 | 64 | 52 |
| | 110698-2 | 153 | 64 | 51 |
| L-2 | 110698-4 | 72 | 30 | 60 |
| | 110698-5 | 72 | 30 | 59 |
| L-3 | 110698-6 | 44 | 18.5 | 86 |
| | 110698-8 | 44 | 18.5 | 92 |
| Helical^{h,i,j,k} | | | | |
| H-1 | 093098-4 | 141 | 58.9 | 38 |
| | 091198-4 | 141 | 58.9 | 25 |
| H-2 | 110398-2 | 60 | 24.9 | 47 |
| | 110398-5 | 60 | 24.9 | 49 |
| H-3 | 111298-1 | 32 | 13.5 | 99 |
| | 111298-2 | 32 | 13.5 | 99 |

Notes:
^{a}Aₘ(cm²) is the membrane surface area
^{b}L(cm) is the active fiber length
^{c}Lₚ(lmh/kPa) is the hydraulic permeability
^{d}Nominal pore diameter = 0.1 μm
^{e}Number of fibers per module, m = 6
^{f}Fiber inside diameter, d_{I} = 1.27 mm
^{g}Fiber outside diameter, dₒ = 1.92 mm
^{h}Rod diameter, d_{rod} for the helical modules = 6.35 mm
ⁱPitch of helical module, p = (m/2π)dₒ = 1.83 mm
^{j}Radius of curvature of the tube in one plane, r = (d_{rod} + dₒ)/2 = 4.14 mm
^{k}Radius of curvature, r_{c} = (r² + p²)/r = 4.95 mm

### Example 9

### The Microfiltration Pilot-Plant System

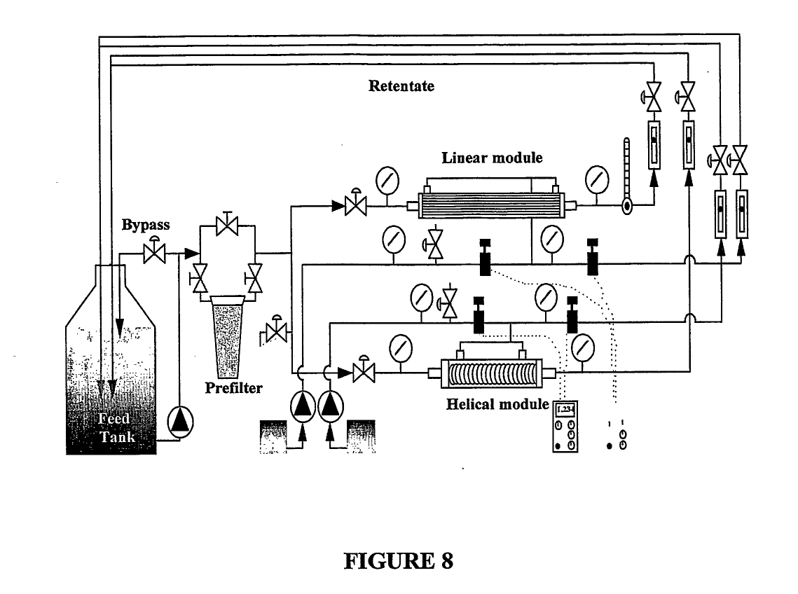

FIG. 8 is a flow diagram of the microfiltration pilot-plant system. This system consisted of two parallel flow lines, which allowed comparison between the linear and helical modules simultaneously for experiments relating to flux. The dual module microfiltration system consisted of a 10 L polypropylene tank (Nalgene, Chicago, Ill.), a diaphragm pump (Mod # F 301010110, Flojet, Irvine, Calif.) and the two membrane modules. A bypass line was used to control the inlet flow rate to a union “T”, which divided the feed flow into two parallel lines, one for each module. Needle valves were placed in front of the modules and on the downstream side to control both pressure and flow rate independently in each line. The inlet pressure of the modules, the transmembrane pressure (TMP) an the pressure drop across the modules (transcartridge pressure) as well as the permeate pressures were measured with digital pressure gauges (Mod # 68920-36, PSITronix, Tulare, Calif.). The retentate and permeate flow rates were measured separately for each fluid stream (flowmeter tube size #14 for retentate streams and #12 for permeate streams, Gilmont, Ill.). For deionized water tests (first phase of experimentation), a 0.2 Plm mean pore-size prefilter (Mod PSCL-SI, Ametek, Sheboygan, Wis.) was used to reduce fouling due to traces of colloids in the water. Two solenoid valves (Type 211, Burtek, Ingelfingen, Germany) located in the permeate line of each module enabled selection between normal operation and constant flux/backwashing procedures. These valves were operated from a control unit (GraLab Model 900, Dimco-Gray Co, Centerville, Ohio). Two peristaltic pumps (Masterflex, 7521, Cole Parmer, Chicago, Ill.), installed on the permeate lines, were used for either backflushing of the modules or operating at constant flux. For the transgenic goat milk experiments, to reduce the dead volume in the system, the 10 L reservoir was replaced by a 1 L graduated flask and the pre-filter was removed from the circuit.

### Example 10

### Characterization of Modules

Twelve hollow fiber modules (6 linear and 6 helical; six pairs, each pair differing in hollow fiber membrane length) were characterized using deionized water with respect to flow parameters. For each module, axial pressure drops were varied and the corresponding axial flow rates recorded. This was first done with the permeate ports closed. Later, this was repeated with permeate ports opened to give a flow rate of 40 ml/min. Hydraulic permeability experiments were then conducted by varying the TMP from 5 kPa to 70 kPa For all the hydraulic permeability tests, the axial flow was maintained at 0.5 I/min corresponding to an exit Reynolds number of 1075. Two similar pairₛ (based on the length of the hollow fiber membranes) comprising of a linear and a helical module were selected for further experimentation with milk.

### Example 11

### Microffitration Characterization With Transgenic Goat Milk

This phase of experiments were conducted to understand and compare the permeation flux and protein transmission behavior of whole transgenic goat milk of the linear and helical modules at different Reynold's numbers (shear rates) and protein concentrations of milk. To study the effect of protem concentration, experiments were run at a fixed Reynolds number with milk samples corresponding to 3, 2, 1, ½, and ⅓ times the normal milk concentration. Dilutions were achieved with addition of DI water and concentrations were obtained by filtering at a very low TNT (15 kPa). To maintain a fixed protein concentration in the bulk, both retentate and permeate were completely recycled to the feed reservoir. In these experiments, the TMP was gradually raised from a low value to the pressure independent region of permeation flux. Thus, flux variation with respect to TMP could also be obtained. Each experiment was conducted separately for a helical and a linear module. The milk samples were preheated to 25° C. in a water bath. Samples (5 ml) were taken from both the retentate and the permeate and analyzed for analyzed for protein concentration by the Bradford (protein) assay.

### Example 12

### Diafiltration Experiments

Milk at concentrations corresponding to 1, 1.5, 2, 2.5, and 3 times the normal milk concentration were used for constant volume diafiltration experiments up to 5 diavolumes. For 1× concentration, diafiltration was started after flushing the system with milk. For 2× concentration, one system volume was collected prior to diafiltration, while maintaining a constant reservoir level with milk addition. The permeate collection volumes for 1.5×, 2.5×, and 3× were ½, 1.5, and 2 times the system volume, respectively. For the first protocol, collected permeate was recycled to the feed along with DI water in the ratio 1:1. These experiments were run at a fixed Reynolds number and at 90% of the pressure corresponding to the pressure independent flux for the linear and helical modules. To study the effect of Reynolds number (shear rate), additional diafiltration experiments were conducted at different Reynolds numers with the same milk concentration of 2×. For these experiments, the permeate was not recycled. Therefore, for these experiments concentration of the feed occurred during the first filtered diavolume. Samples (5 ml) were taken from the retentate and permeate streams at regular intervals and analyzed for protein and IgG concentrations.

### Example 13

### Cleaning Protocol

The following cleaning protocol was used. After each experiment, the entire system was rinsed with deionized water at an axial flow velocity of 2 m/s for 5 minutes with the permeate ports fully opened. This was followed by recycling cleaning agents Ultrasil 10—detergent at 0.5 wt. % and Ultrasil 02—surfactant at 0.1 wt. % at an axial velocity of 2 m/s at 45° C. for 30 minutes. The cleaning agents (altrasil 02, 10, Ecolab, St. Paul, Minn.) were then flushed from of the system for 10 minutes with deionized water. This was followed by sterilization with 0.1 wt. % NaOCl at 40° C. for 10 minutes at 0.33 m/sec. This low velocity was chosen to give sufficient residence time for the bleach to act on the membrane modules. The membranes were stored in this dilute bleach solution till the next experiment. Prior to a new experiment the dilute bleach solution was flushed out by rinsing with deionized water for 10 minutes at 2 m/s velocity.

### Example 14

### Assay Protocols

The Bradford assay (Bio-Rad, Hercules, Calif.) was used to determine protein concentration. Bovine lyophilized casein powder (Sigma, St. Louis, Mo.) was used as a standard and readings were taken in disposable 5 ml polystyrene cuvettes (Bio-Rad, Hercules, Calif.). The absorbance readings with the spectrophotometer (Hitachi, Japan) were taken in the visible range at 595 nm wavelength.

IgG assay was based on the protocol provided by GTC Biotherapeutics (Framingham, Mass.). Briefly, a protein A affinity chromatography (PA ImmunoDetection™ sensor cartridge (2.1×30 mm) (PerSeptive Biosystems, Framingham, Mass.) was used to obtain IgG concentrations in the various goat milk streams. 1.5 ml of milk samples were pipetted into 2 ml Eppendorf centrifuge tubes and centrifuged at 21000 g for 30 min. The milk separated into a top fat layer, a clear whey solution, and a casein pellet. 0.75 ml of the clear whey phase was carefullly extracted with a pipette after puncturing the fat layer. This was pipetted into centrifuge tubes (Spin-X tubes, Corning, N.Y.) with 0.45 μm pore size cellulose acetate membranes and was centrifuged at 21000 g for 15 min. The clarified permeate was then injected into the HPLC column. For the permeate samples, sample preparation was unnecessary. A HPLC (Waters 510 with Millennium 2010 operating system) with a 486 UV detector and U6K sample injector were used (Waters Corp., Milford, Mass.). The loading buffer was 10 mM phosphate buffer and 150 mM NaCl at pH 7.20+0.05, while the elution buffer was 12 mM HCl with 150 mM NaCl. The pump flow rate was set at 2 ml/min., and the detector wave length at 280 nm. The injection volume was 10 μL for milk and 20 to 40 μL for permeate samples. A calibration graph was constructed by injecting different dilutions of IgG fusion protein (GTC Biotherapeutics, Framingham, Mass.). Loading buffer was passed through the column for 10 minutes followed by sample injection and loading buffer again for 5 minutes. After this, elution buffer was run for 10 minutes. A clean peak corresponding to IgG fusion protein was detected at around 6.5 minutes into the elution phase. Area obtained by peak integration was compared with the calibration graph to obtain the IgG concentration of the sample after dividing by the sample volume. Care was taken to ensure that all readings were within the range of the calibration graph. This was done by adjusting the sample injection quantities.

Fat content was measured by the Gerber method which is approved for use by dairies in USA. Eleven ml of preheated milk sample (37° C.) was added to 10 ml of sulfuric acid in a butyrometer. 1 ml of amyl alcohol was added, and the butyrometer was capped with a special stopper. Shaking the butyrometer ensured digestion of the proteins by sulfuric acid. The butyrometer was then inverted and centrifuged for 6 minutes at 350 g. After this, the butyrometer was immersed in water bath at 65° C. for 5 min. The fat appeared as a clear liquid, and the quantity was read out as a volume percentage in the graduated section of the butyrometer.

### Example 15

### Model Predictions

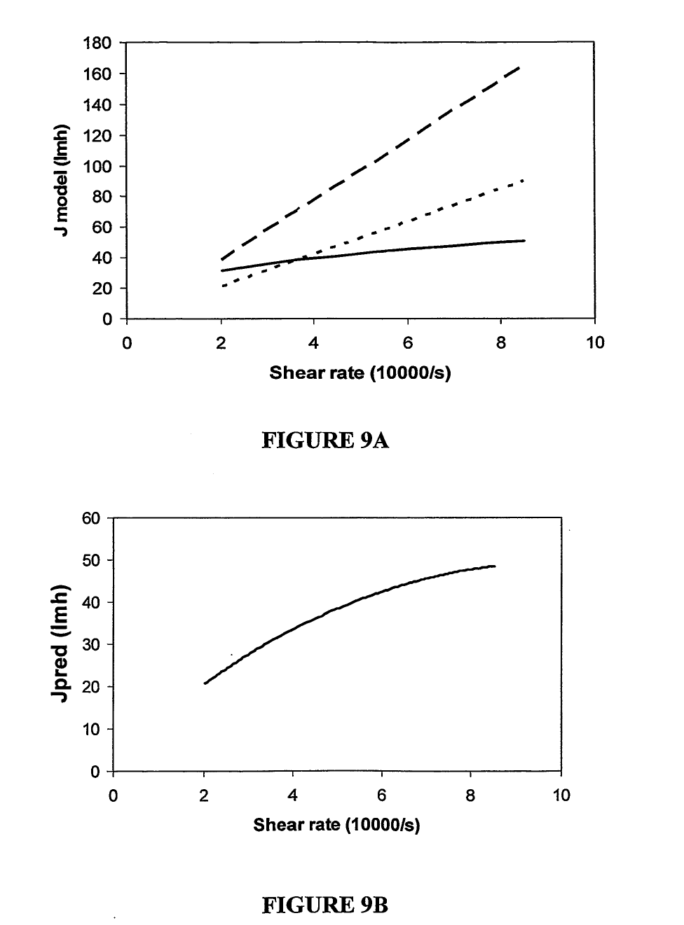

Model predicted pressure-independent permeation fluxes during microfiltration of whole transgenic goat milk at 298 K, with a 6-fiber hollow fiber module of length 300 mm, internal diameter 1.27 mm, and pore diameter of 100 nm, were plotted against mean axial shear rate for mono-disperse suspensions of IgG, casein micelles, and fat globules, shown in FIG. 9A. The permeation fluxes were based on back-transport of these particles from the cake at the wall. The minimum of these fluxes was used as the first estimate for the permeation flux of whole transgenic goat milk which is a poly-disperse suspension comprising these three particles as the dominant specie. This value was further refined by successive iterations in the model to the final value of the pressure-independent poly-disperse permeation flux for whole transgenic goat milk. This is plotted against mean axial shear rate, shown in FIG. 9B. From FIG. 9A, it is seen that for shear rates below 40,000 s⁻¹, the IgG molecules exhibit higher back-transport than the casein micelles, a casein cake layer is expected to limit the pressure-independent permeation flux. A high value of IgG transmission is expected in the casein cake regime as the interstitial gap between the casein micelle spheres will be ≧150 nm which is much higher than 20 nm the diameter of the IgG molecules. For shear rates higher than 40,000 s⁻¹, the model predicts that the cake layer will be mainly composed of IgG. This will form a tighter layer resulting in reduced IgG transport.

### Example 16

### Microfiltration Characterization With DI Water

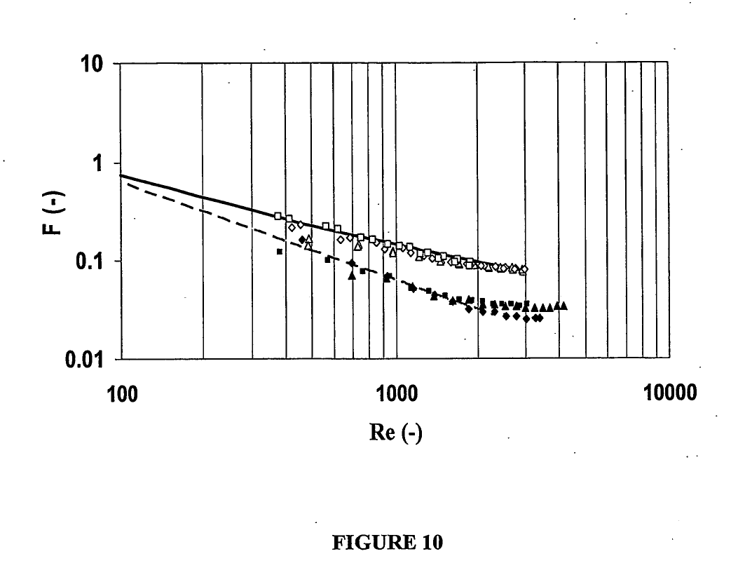

Experiments were performed with DI water for 12 modules as per Table 5 to determine the hydraulic permeability and friction factor. It is seen in FIG. 10, that the friction factor followed the well known Hagen Poiseuille equation for the linear modules and the Mishra-Gupta equation for helical modules. The intermediate length modules, L-2 for linear and H-2 for helical were selected for further experiments with transgenic whole goat milk.

### Example 17

### Microfiltration Characterization With Whole Goat Milk

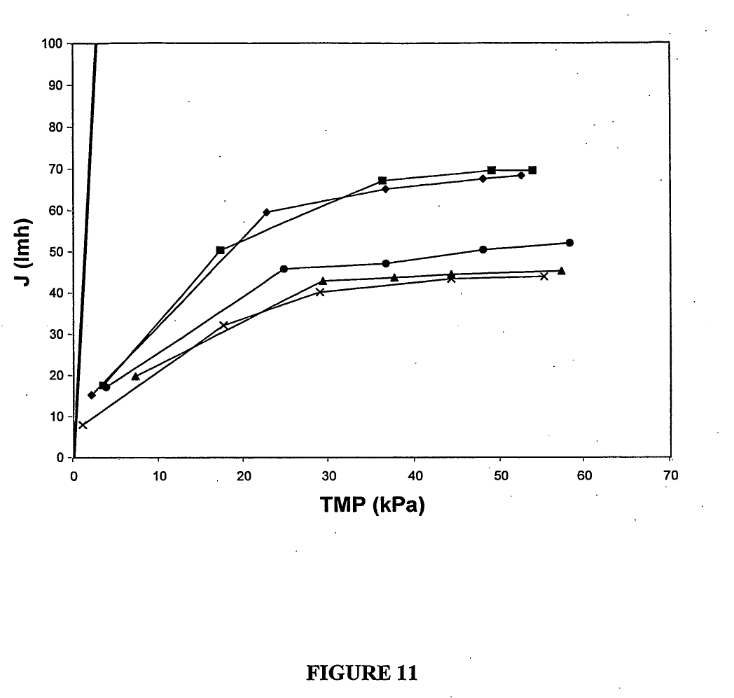

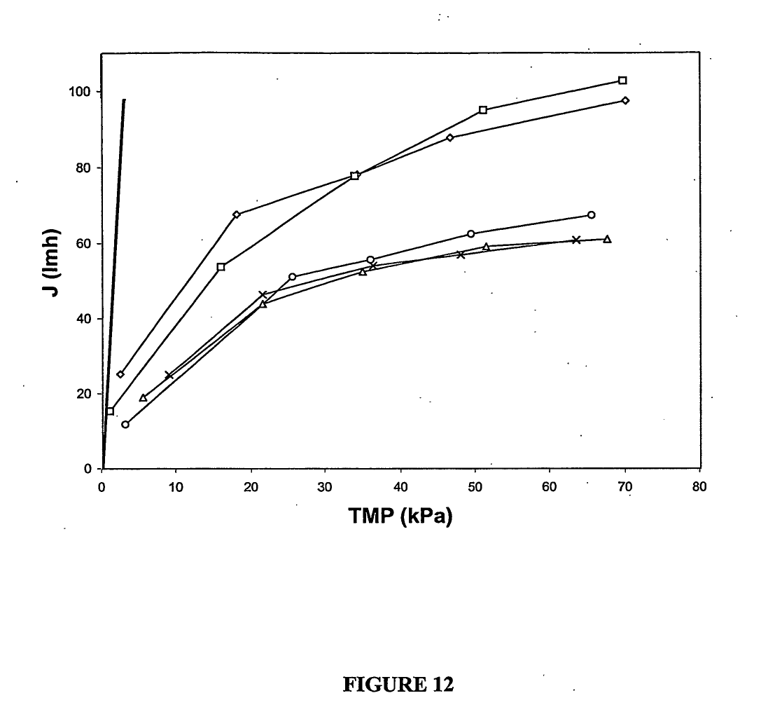

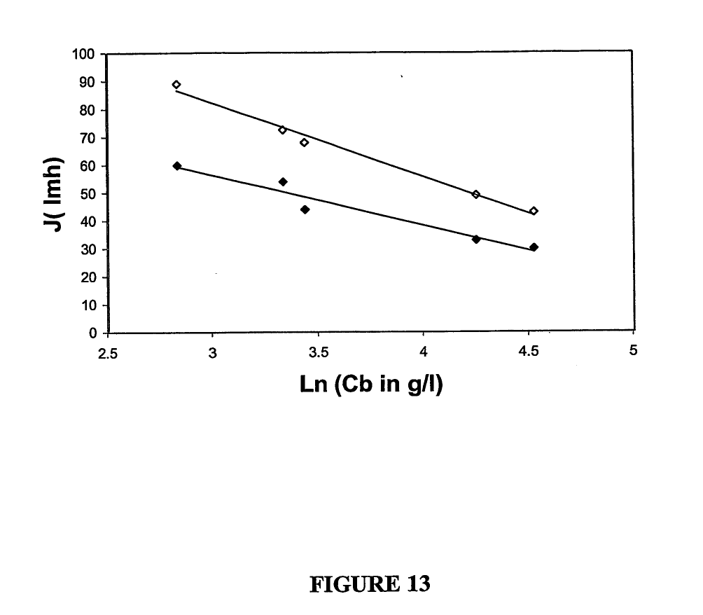

The data in FIG. 11 and FIG. 12 indicate that the classical gel-polarization model appears to be valid for milk filtration. This was further confirmed by a plot of flux versus the logarithm of the protein feed concentration which yielded straight lines for both modules, shown in FIG. 13. The data indicate a significantly higher mass transfer coefficient for the helical module as compared to the linear module (26.5 versus 18.2 lmh) as expected (Luque et al., “A New Coiled Hollow-Fiber Module Design for Enhanced Microfiltration Performance in Biotechnology,” Biotechnol. Bioeng. 65:247-257 (1999); Belfort et al., “The Behavior of Suspensions and Macromolecular Solutions in Crossflow Microfiltration,” J. Membr. Sci. 96:1-58 (1994); U.S. Pat. No. RE 37,759 to Belfort, which are hereby incorporated by reference in their entirety). The plot is made according to the gel polarization model J=k Ln(C_{w}/C_{b}). Based on the x-intercept, C_{w} (helical)=448 g/l and C_{w} (linear)=443 g/l. These values compare well with values reported in literature of 280 g/l for whey protein filtration (Zeman et al., “Microfiltration and Ultrafiltration Principles and Applications,” New York: Marcel Dekker, Inc. (1996), which is hereby incorporated by reference in its entirety). The transmembrane pressures corresponding to the pressure-independent flux, were about 60 kPa for the linear and 70 kPa for the helical modules.

### Example 18

### Diaffitration Experiments

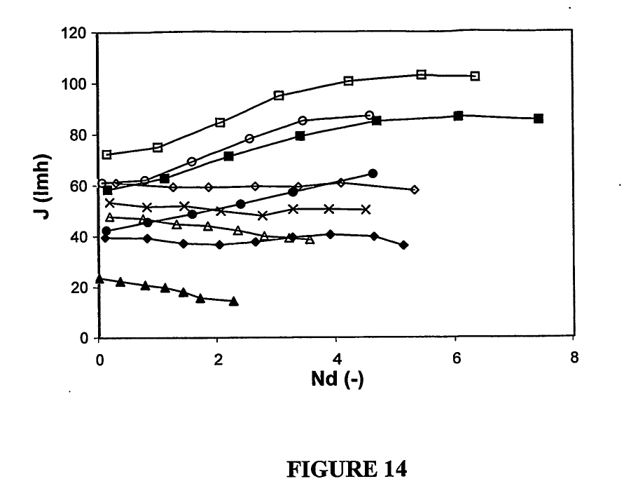

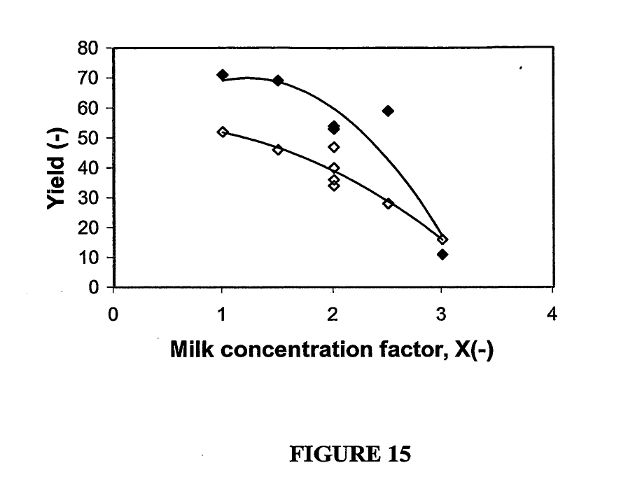

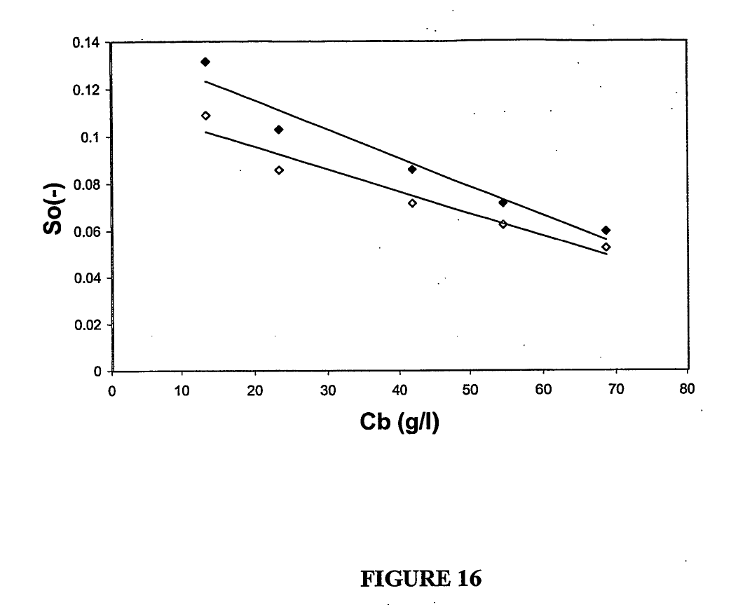

A series of diafiltration experiments were conducted to study the IgG transmission and permeation flux behavior with the passage of diafiltration. Experiments at a fixed Reynolds number of 1400 and different starting milk concentrations indicated similar flux trends for both modules, shown in FIG. 14. For each case, the helical module gave a 55 to 70% higher flux compared with the linear modules. For lower concentrations, 1× and 1.5×, the flux increased with diavolumes. This behavior is explained by two competing phenomena There was a progressive reduction of viscosity in the bulk solution due to the reduction in total solids content especially the sugars, salts, and low molecular weight moieties. This enhanced the back-transport of casein as well as IgG, the putative foulants according to an earlier hypothesis, and a higher forward convective transport of solvent could be supported without cake build-up. For 2× and 2.5× concentrations the flux remained steady through most of the run with a drop at the end. This was probably due to the cancellation of the deleterious effect of cake build-up and the beneficial effect of reduction in suspension viscosity. For higher diavolumes, cake build-up overwhelmed the effect of viscosity reduction and a decreasing trend was obtained at the end of the run. This is expected, because viscosity reduction tapered off with filtration as the total solids fraction became constant due to low sieving at the end of diafiltration. For 3X concentration, there was a continual reduction of permeation flux with diafiltration during the run. This is explained by the overriding influence of cake build-up due to poor back-transport as well as high viscosity of the suspension. It was also found that the IgG and whey protein transmission was lower for the helical module, shown FIG. 15 and FIG. 16.

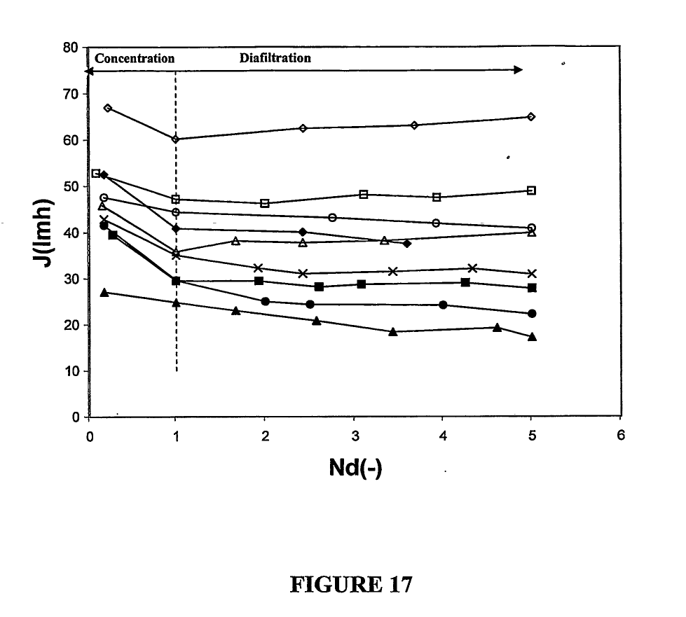

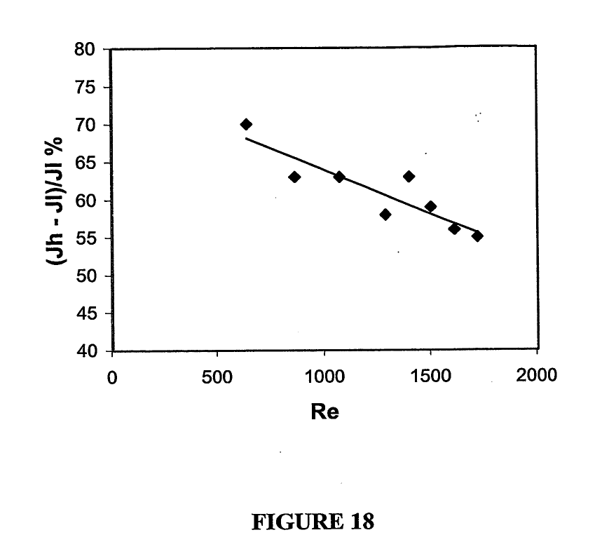

In the second phase of diafiltration, shown in FIG. 17, it was found that for each case there is an increase in permeation flux with Reynolds number. As indicated earlier, in these experiments, conducted with a milk concentration of 2×, the permeate was not recycled. Hence, the first diavolume comprised the concentrating phase and as expected, a significant drop in permeation flux was observed during this phase. The other interesting point is that for high Reynolds number flow the permeation flux rose after the concentration phase for the helical module. In all other cases, the flux dropped. This is explained by the fact that at the same Reynolds number the helical module has a wall shear rate of almost twice that of the linear module. At these high shear values, the cake build up was slow or non-existent and the increase in permeation flux was due to the reduction in suspension viscosity. FIG. 18 indicates that the helical module had a permeation flux of 55 to 70% higher than the linear module for the same Reynolds number.

### Example 19

### Fit of Experimental Data and Predictions

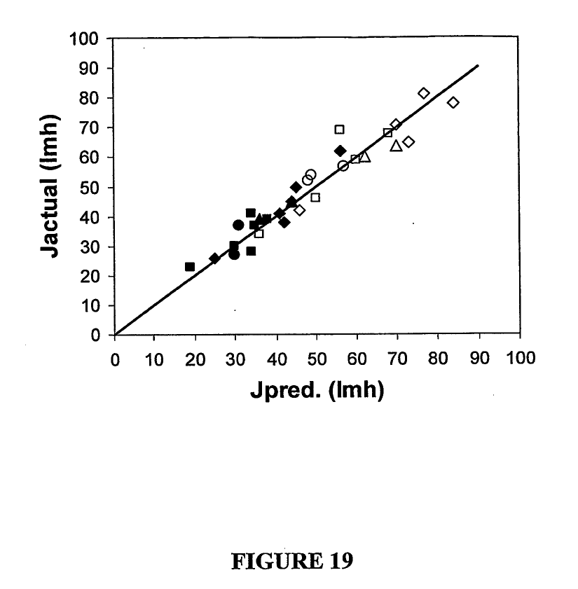

A very good fit (r²=0.92) between the model and experiments for a wide range of operating conditions (near the pressure-independent flux regime) with variations in milk concentration, temperature, and Reynolds numers was obtained, as seen in FIG. 19. For the helical module, in all cases except at a Reynolds number of 640, the shear rate is higher than 40,000 sec⁻¹, indicating that the IgG molecules will build up the cake instead of casein micelles. This explains the lower protein transmission but high flux while operating under high wall shear with the helical module. Operating at high shear rates, but at a permeation flux which is significantly lower than the value predicted by the model is recommended. In addition, to prevent increase in permeation flux during diafiltration at constant pressure, filtration at constant permeation flux rather than constant transmembrane pressure is suggested. Under these conditions a cake will likely not form completely on the membrane and good protein transmission of the target molecule, IgG, during milk microfiltration in the diafiltration mode will be observed.

This concept has been addressed by others (Field et al., “Critical Flux Concept for Microfiltration Fouling,” J. Membr. Sci. 100:259-272 (1994); Ould-Dris et al., “Effect of Cake Thickness and Particle Polydispersity on Prediction of Permeate Flux in Microfiltration of Particulate Suspensions by a Hydrodynamic Diffusion Model,” J. Membr. Sci. 164:211-227 (2000); Gesan-Guiziou et al., “Critical Stability Conditions in Skimmed Milk Crossflow Microfiltration: Inpact on Operating Modes,” Lait 80:129-140 (2000), which are hereby incorporated by reference in their entirety). The model allows the establishment, a priori, of a safe operating permeation flux. This can be generalized to mnicrofiltration of other well characterized poly-disperse suspensions to arrive at the safe permeation flux. This also underscores the concept of constant permeation flux operation as preferable to constant pressure microfiltration. This is because with a constant pressure approach, it is likely that the safe value of permeation flux, above which a cake layer forms completely, will be exceeded during the initial stages of the run and during the course of diafiltration due to the reduction of protein volume fraction and bulk viscosity due to lower volume fraction of solids in the bulk feed.

A series of experimental results with whole transgenic goat milk under various operating conditions of temperature, wall shear rate, and milk concentrations were presented herein. These results validate the predictive aggregate transport model for microfiltration of combined macromolecular solutions and poly-isperse suspensions of the present invention. Milk, being an extremely complicated poly-disperse suspension, provided a suitable test suspension for the method disclosed herein. Further to the recommendations herein, salient features and benefits that can be derived from this model. Crossflow microfiltration performance of different poly-disperse suspensions can be predicted apriori. Currently, in the absence of a general theory, numerous experiments need to be performed in the laboratory and bench scales for each feed type. Therefore, using the model, there is a tremendous potential for saving time and labor. The model can be used with different geometries. The model can determine the nature of the filter cake. The model, being theoretical, can be used for scale-up and scale-down for industrial or laboratory applications. This is a major pitfall of empirical methods which are valid only for the operating region and scale. The computerized version of the model can be interfaced with other software packages for optimzg diafiltration for the optimum plant operation.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for predicting pressure independent permeation flux and target molecule yield in a permeate resulting from crossflow membrane filtration of particles in a poly-disperse suspension, said method comprising:
determining particle size distribution of the poly-disperse suspension;
determining equivalent spherical radii of the particles;
determining viscosity of the suspension;
determining maximum back-transport velocity (uᵢ) for all particles;
estimating maximum aggregate packing volume fraction (φ_{M}) for all particles at a wall of the filtration membrane from geometric considerations;
selecting the particle that gives a minimum permeation flux at a given filtration membrane shear rate, wherein the selected particle has a radius (αᵢ);
determing a predicted permeation flux (J);
determining packing density φ_{wi} at a membrane wall for each particle size (αⱼ for j≠i) at the predicted permeation flux;
determining interstitial packing density (φ_{wiinterstice}) of particles in the suspension which are the smallest;
determining minimum pore diameter (2rₘᵢₙᵢₘᵤₘ) based on the packing density of each particle; and
estimating yield of a target species in the filtration permeate by calculating observed sieving coefficient (Sₒ) for the target species, thereby predicting permeation flux and target molecule yield of the poly-disperse suspension during crossflow filtration.

2. The method according to claim 1, wherein said determining viscosity of the suspension is carried out by using a modified Einstein-Smoluchowski equation: η/η₀1+2.5φ_{b}+k₁φ_{b}², where η is bulk fluid viscosity (kg/m.s) of the suspension, η₀ is bulk fluid viscosity of the suspension without solute (kg/m.s), k₁ is particle shape factor (−), and φ_{b} is particle volume fraction in the bulk suspension (−).

3. The method according to claim 1, wherein said determining viscosity of the suspension is carried out by experiment.

4. The method according to claim 1, wherein said determining maximum back-transport velocity (uᵢ) comprises:
calculating Brownian diffusion (J_{B}) for all particles, where J_{B}=0.114(γk²T²/η²α₂L)^{1/3}ln (φ_{w}/φ_{b});
calculating inertial lift (J₁) for all particles, where J₁=0.036ρα³γ²/η;
calculating shear induced diffusion (J_{S}) for all particles where J_{S}=0.078(α⁴/L)^{1/3}γln (φ_{w}/φ_{b}), wherein γ is wall shear rate (s⁻¹), κ Boltzmann constant (J/mol K), T is temperature (K), η is bulk fluid viscosity (kg/m.s), αᵢ is radius of species i(m), L is tube length (m), φ_{w} is particle volume fraction at the filtration membrane (−), φ_{b} is the particle volume fraction in the bulk suspension (−), and ρ is particle density kg/m³); and
selecting Jmax for each particle, wherein Jmax=uᵢ whereby maximum back-transport for each particle is determined.

5. The method according to claim 1, wherein said estimating maximum aggregate packing volume fraction (φ_{M}) at the membrane wall for a suspension comprises:
determining particle size (αᵢ) of species (i) in the suspension;
determning if the size ratio of the particles is >10, such that αᵢ₊₁>10αᵢ for all αᵢ; and
calculating the maximum aggregate packing volume fraction (φ_{Mn}) by φ_{Mn}=φₘ+φₘ(1−φ_{Mn-1}), where φ_{M}=Φₘ is set to 0.64 when the size ratio of the particles is >10, such that α_{i+I}>10αᵢ for all αᵢ.

6. The method according to claim 5, wherein the suspension comprises 3 particle sizes and wherein α₁=10α₂>α₃, said method further comprising:
calculating φ_{M}=φₘ+φₘ(1−φₘ)+0.74[1−{φₘ+φₘ(1−φₘ)}], wherein φₘ is set to 0.64.

7. The method according to claim 1, wherein said estimating maximum aggregate packing volume fraction (φ_{M}) at the membrane wall for a suspension comprising two particles, such that α₁>10 α₂, is carried out by calculating φ_{M}=φₘ+0.74(1−φₘ), where φₘ is set to 0.64.

8. The method according to claim 1, wherein said estimating maximum aggregate packing volume fraction (φ_{M}) at the membrane wall comprises:
calculating a maximum radius ratio of all particles;
determining if said maximum radius ratio is <10; and
setting φ_{M} as 0.68, where said maximum radius ratio is <10.

9. The method according to claim 1, wherein said selecting the particle that gives the minimum permeation flux (J) comprises:
calculating Brownian diffusion (J_{B}) for all particles, where J_{B}=0.114(γκ²T²/η²α²L)^{1/3}ln (φ_{w}/φ_{b});
calculating inertial lift (J₁) for all particles, where J₁=0.036ρα³γ²/η,
calculating shear induced diffusion (J_{S}) for all particles, where J_{S}=0.078(α⁴/L)^{1/3}ln (φ_{w}/φ_{b}), wherein y is wall shear rate (s⁻¹), κ is Boltzmann constant (J/mol K), Tis temperature (K), η is bulk fluid viscosity (kg/m.s), αᵢ is radius of species i (m), L is tube length (m), φ_{w} is particle volume fraction at the membrane wall (−), φ_{b} is the particle volume fraction in the bulk suspension (−), and ρ is particle density (kg/m³);
determining a Jmax value for each particle; and
selecting a Jₘₐₓ value from among all Jmax values that is the lowest, thereby selecting the minimum permeation flux (j).

10. The method according to claim 1, wherein said determining packing density at the membrane wall (φ_{wj}) for all particles at the predicted permeation flux (αⱼ for j≠i) comprises:
back-calculating the value of φ_{wj} such that φ_{wj} gives the predicted permeation flux (J) of selected particle (αᵢ) using the equation for back-transport that establishes maximum back transport for each particle (αⱼ for j=i), wherein the equation is either J_{B}=0.114(γκ²T²/η²α²L)^{1/3}ln(100 _{w}/φ_{b}) or J_{S}=0.078(α⁴/L)^{1/3}γ ln(φ_{w}/φ_{b}), or J₁=0.036ρα³γ²/η, where γ is wall shear rate (s⁻¹), κ is Boltzmann constant (J/mol K), T is temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³).

11. The method according to claim 10, wherein said determining packing density frther comprises:
determining if the predicted permeation flux is established by inertial lift (J₁) for one particle type;
determining if u_{jI}≧10J; and
setting φ_{wj}=0, when one particle type is established by inertial lift (J_{I}) and u_{jI}≧0J.

12. The method according to claim 10, wherein said determining packing density frrther comprises:
determiing if the predicted permeation flux is established by inertial lift (J_{I}) for one particle type;
determining if u_{jI}<10J, and
determining packing density (φ_{wj}) by φ_{wjI}=φ_{M}−Σφ_{wj} when u_{jI}<10J and one particle type is established by inertial lift.

13. The method according to claim 10, wherein said determing packing density further comprises:
detemirining if permeation flux is established by inertial lift (J₁) for more than one particle type;
determining if uⱼ₁<10J for the particles; and
determining packing density by φ_{wjI}=φ_{M}−Σφ_{wj} when u_{jI}<10J and permeation flux is established by inertial lift for more than one particle type.

14. The method according to claim 10, wherein said determining packing density further comprises:
determining if permeation flux is established by J_{I} for more than one particle type (JI1, jI2, . . . jIn); and
determining packing density at the membrane wall by
φ_{wjI1}+φ_{wjI2}=φ_{M}−Σφ_{wj}, wherein φ_{wjI1}:φ_{wjI2}=φ_{bjI1} u_{jI2}:φ_{bjI2} u_{jI1},
where j≠jI1 or jI2 and u_{jI1}, u_{jI2}<10J, when permeation flux is established by J_{I} for more than one particle type.

15. The method according to claim 1, wherein said determining interstitial packing density (φ_{wiinterstice}) of the smallest particle is carried out by φ_{wiinterstice}=φ_{wicorrected}/(1−Σφ_{wjcorreted}), wherein φ_{wicorrected}=φ_{M}[(φ_{wi})/Σφ_{wi}], where φ_{wi} is the particle volume fraction at the membrane wall (−) for particle i.

16. The method according to claim 1, wherein said determining minimum pore diameter (2rₘᵢₙᵢₘᵤₘ) is carried out using
2rₘᵢₙᵢₘᵤₘ=αᵢ{√2[4(4/3)π/φ_{wiinterstice}]^{1/3}−2}, where α is radius of species i(m) and rₘᵢₙᵢₘᵤₘ is a minimum equivalent cake void radius for all cake types (m).

17. The method according to claim 1, wherein said estimating yield of a target species comprises:
calculating observed sieving coefficient (S_{α}), where Sₒ=S_{α}(1−S_{α}) exp(−J/k)+S_{α}), wherein actual sieving coefficient S_{α} is obtained from S_{α}=(S_{∝} exp(Peₘ))/(S_{∝}+exp(Peₘ)−1), wall Peclet number, Peₘ is obtained from Peₘ=(Jδₘ/D)(S_{∝}/εφK_{d}), where J is permeation flux (m/s), δₘ is taken as the side of the face centered cube of the particles of radius αᵢ that forms the controlling cake for transmission, δₘ=α=αᵢ[(4(4/3)π)/φ_{interstice}]^{1/3}, D is molecular diffusion coefficient (m²/s), intrinsic sieving coefficient S_{∝} is obtained from S_{∝ =(}1−λ)²[2−(1−λ)²] exp(−0.7146λ²), λ=rₛ/rₘᵢₙ, where rₛ is solute radius (m) and rₘᵢₙ is a minimum equivalent cake void radius for all cake types (m), φ is equilibrium partition coefficient between membrane pore and suspension (−), ε is cake/mernbrane porosity (−), K_{d} is hindrance factor for diffusive transport (−), and k is mass transfer coefficient (m/s).

18. The method according to claim 1, wherein crossflow-filtration is carried out in a diafiltration mode, and the yield of the target species is estimated after N_{d} diavolumes as Yield=1−exp(−N_{d}S_{oaverage}) where S_{oaverage} is average observed sieving coefficient during diafiltration (−), where S_{α}=S₆₀ /((1−S_{α}) exp(−J/k)+S_{α}), where actual sieving coefficient S_{α} is obtained from S_{α} =(S_{∝} exp(Peₘ))/(S_{∝}+exp(Peₘ)−1), where Jis permeation flux (m/s), wall Peclet number, Peₘ, is obtained from Peₘ=(Jδ_{m/D)(S}_{∝}/εφK_{d}), where δₘ is taken as the side of the face centered cube of the particles of radius αᵢ that forms the controlling cake for transmission, where δₘ=α=αᵢ[(4(4/3))π/φ_{iinterstice}]^{1/3}, D is molecular diffusion coefficient (m²/s), intrinsic sieving coefficient S,- is obtained from S_{∝}=(1−λ)²[2−(1−λ)²] exp(−0.7146λ²), λ=rₛ/rₘᵢₙ, where rₛ is solute radius (m) and rₘᵢₙ is a minimum equivalent cake void radius for all cake types (m), φ is equilibrium partition coefficient between membrane pore and suspension (−), ε is cake/membrane porosity (−), K_{d} is hindrance factor for diffusive transport (−), and k is mass transfer coefficient (m/s).

19. The method according to claim 1 further comprising:
re-calculating packing density for all particle sizes if packing constraints are not satisfied based on initial determination of packing densities of the particles at the wall.

20. The method according to claim 19 further comprising:
correcting packing density using φ_{wicorrected}=φ_{M}[(φ_{wi})/Σφ_{wi}];
reevaluating J for the particle selected as having the minimum permeation flux based on φ_{wicorrected}=φ_{M}[(φ_{wi})/Σφ_{wi}]; and
reevaluating maximum back-transport velocity (uᵢ).

21. The method according to claim 20 frither comprising:
repeating the steps of claim 17 until a desired packing constraint is met.

22. The method according to claim 1 further comprising:
refining the yield of the target species.

23. The method according to claim 22, wherein said refining the yield comprises:
determining whether the suspension has a low, intermediate, or high operating shear rate leading to different yield regimes, wherein a suspension at a low operating shear rate leads to an Sₒ≧0.75 corresponding to a yield ≧0.95, an intermediate operating shear rate leads to 0<Sₒ<0.75 corresponding to yield from 0 to 95%, or a high operating shear rate leads to an S₀≅0, wherein Sₒ=S_{α}/((1−S_{α}) exp(−J/k)+S_{α}), wherein actual sieving coefficient S_{α} is obtained from S_{α} =(S_{∝} exp(Peₘ))/(S_{∝}+exp(Peₘ)−1), wall Peclet number, Peₘ is obtained from Peₘ=(Jδₘ/D)(S_{∝}/εφK_{d}), where Jis permeation flux (m/s), δₘ is taken as the side of the face centered cube of the particles of radius αᵢ that forms the controlling cake for transmission, δₘ=α=αᵢ[(4(4/3)π)/φ_{iinterstice]}^{1/3}, D is molecular diffusion coefficient (m²/s), intrinsic sieving coefficient S_{∝} is obtained from S_{∝}=(1−λ)²[2−(1−λ)²] exp(−0.7146λ²), λ=rₛ/rₘᵢₙ, where rₛ is solute radius (m) and rₘᵢₙ is a minimum equivalent cake void radius for all cake types (m), φ is equilibrium partition coefficient between membrane pore and suspension (−), ε is cake/membrane porosity (−), K_{d} is hindrance factor for diffusive transport (−), and k is mass transfer coefficient (m/s).

24. The method according to claim 23, wherein an intermediate operating shear rate is determined as leading to 0<Sₒ<0.75, said method further comprising:
calculating stagnant film flux (J) equation for non-retentive membranes wherein J=k ln [(φ_{wi}−φₚₑᵣₘₑₐₜₑᵢ)/(φ_{bi}−φₚₑᵣₘₑₐₜₑᵢ)]≅k ln [φ_{wi}/φ_{bi}(1−Sₒ)], wherein (φ_{wi}>>φₚₑᵣₘₑₐₜₑᵢ; and
correcting Sₒ by replacing J=solvent permeation flux (m/s) with the stagnant film flux (J) equation for non-retentive membranes in the equation for observing sieving coefficient, Sₒ, where Sₒ=S_{α}/((1−S_{α}) exp(−J/k)+S_{α}).

25. The method according to claim 1 further comprising:
constructing a plot of the predicted permeation flux and yield versus wall shear rate, thereby predicting permeation flux and target molecule yield of the poly-disperse suspension during microfiltration.

26. The method according to claim 1, wherein filtration is selected from the group consisting of microfiltration and ultrafiltration.

27. The method according to claim 1, wherein filtration is carried out with a filter selected from the group consisting of a flat sheet filter, hollow-fiber filter, and a helical filter.

28. The method according to claim 1, wherein the suspension is selected from the group consisting of streams from biomedical and bio-processing industries, waste water, surface water, environmental pollutants, industrial waste streams, and industrial feed streams.

29. The method according to claim 28, wherein the suspension is a stream from biomedical and bio-processing industries selected from the group consisting of proteins, cells, nucleic acids, colloids, milk, and suspended particles.

30. A method for determining packing density of particles of a poly-disperse suspension at a membrane wall, said method comprising:
providing a predicted permeation flux (J);
determining packing density for all particle sizes at the predicted permeation flux; and
determining interstitial packing density (φ_{wiinterstice}) of particles in the suspension which are smallest, thereby determining packing density at the membrane wall of particles of the poly-disperse suspension.

31. The method according to claim 30, wherein said determining packing density at the membrane wall (φ_{wj}) for all other particles at the predicted permeation flux (αⱼ for j≠i) comprises:
back-calculating the value of φ_{wj} such that φ_{wj} gives the predicted permeation flux (J) of selected particle (αᵢ), using the equation for back-transport that establishes maximum back transport for each particle (αⱼ for j=i), wherein the equation is either J_{B}=0.114(γκ²Γ²/η²α²L)^{1/3} ln(φ_{w}/φ_{b}) or J_{S}=0.078(α⁴/L)^{1/3} γln(φ_{w}/φ_{b}), or J_{I}=0.036ρα³γ²/η, where γ is wall shear rate (s⁻¹), κ is Boltzmann constant (J/mol K), Γ is temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³).

32. The method according to claim 31, wherein said determining packing density furher comprises:
determining if the predicted permeation flux is established by inertial lift (J_{I}) for one particle type;
determining if u_{jI}≧10J, and
setting φ_{wj}=0, when one particle type is established by inertial lift (J_{I}).

33. The method according to claim 31, wherein said determining packing density further comprises:
determining if the predicted permeation flux is established by inertial lift (J_{I}) for one particle type;
determining if u_{jI}<10J; and
determining packing density (φ_{wj}) by φ_{wjI}=φₘ−Σφ_{w} when u_{jI}<10J and one particle type is established by inertial lift.

34. The method according to claim 31, wherein said determining packing density further comprises:
determining if permeation flux is established by inertial lift (J_{I}) for more than one particle type;
determining if u_{jI}<10J for the particles; and
determining packing density by φ_{wjI}=φ_{M}−Σφ_{wj} when u_{jI}<10J and permeation flux is established by inertial lift for more than one particle type.

35. The method according to claim 31, wherein said determining packing density fther comprises:
determining if permeation flux is established by J_{I} for more than one particle type (jI1, jI2, . . . jIn); and
determining packing density at the membrane wall by
φ_{wjI1}+φ^{wjI2}=φ_{M}−Σφ_{wj}, wherein φ_{wjI1}:φ_{wjI2}=φ_{bjI1} uⱼᵢ₂: φ_{bjI2} u_{jI1},
where j≠jI1 or jI2 and u_{jI1}, u_{jI2}<10J, when permeation flux is established by J_{I} for more than one particle type.

36. The method according to claim 30, wherein said determining interstitial packing density (φ_{wiintersyice}) of the smallest particle is carried out by
φ_{wiinterstice}=φ_{wicorrected}/(1−Σφwjcorrected), wherein φ_{wicorrected}=φ_{M}[(φ_{wi}))/Σφ_{wi}],
where φ_{wi} is the particle volume fraction at the membrane wall (−) for particle i.

37. The method according to claim 31 further comprising:
re-calculating pacling density for all particle sizes and
determining if packing constraints are not satisfied based on initial determination of packing densities of the particles at the wall.

38. The method according to claim 37 further comprising:
correcting packing density by using φ_{wicorrected}=φ_{M}[(φ_{wi})/Σφ_{wi};
reevaluating J for the particle selected as having the minimum permeation flux based on φ_{wicorrected}=φ_{M}[(φ_{wi})/Σφ_{wi}]; and
reevaluating maximum back-transport velocity (uᵢ).

39. The method according to claim 30, wherein filtration is selected from the group consisting of microfiltration and ultrafiltration.

40. A method for predicting pressure independent permeation flux for crossflow membrane filtration of a poly-disperse suspension, said method comprising:
determining viscosity of the suspension;
determining maximum back-transport velocity (uᵢ) for all particles;
estimating maximum aggregate packing volume fraction (φ_{M}) for all particles at a wall of the filtration membrane from geometric considerations;
selecting the particle that gives a minimum permeation flux at a given filtration membrane shear rate, wherein the selected particle has a radius (αᵢ);
determining a predicted permeation flux (J); and
determining packing density (φ_{wj}) at the membrane wall for each particle size (αⱼ for j≠i) at the predicted permeation flux, thereby predicting pressure independent permeation flux for the suspension.

41. The method according to claim 40 further comprising:
re-calculating packing density for all particle sizes if packing constraints are not satisfied based on initial determination of packing densities at the wall.

42. The method according to claim 41 frther comprising:
correcting packing density using φ_{wicorreced}=φ_{M}[(φ_{wi})/Σφ_{wi}];
reevaluating J for the particle selected as having the minimum permeation flux based on φ_{wicorrected=φ}_{M [(φ}_{wi})/Σφ_{wi}]; and
reevaluating maximum back-transport velocity (uᵢ).

43. The method according to claim 40, wherein said determining viscosity of the suspension is carried out by using a modified Einstein-Smoluchowski equation: η/η₀=1+2.5φ_{b}+k₁φ_{b}², where η is bulk fluid viscosity (kg/m.s) of the suspension, η is bulk fluid viscosity of the suspension without solute (kg/m.s), k₁ is particle shape factor (−), and φ_{b} is particle volume fraction in the bulk suspension.

44. The method according to claim 40, wherein said determining viscosity of the suspension is carried out by experiment.

45. The method according to claim 40, wherein said determining maximum back-transport velocity (uᵢ) comprises:
calculating Brownian difffusion (J_{B}) for all particles, where J_{B}=0.114(γκ²T²/η²α²L)^{1/3} ln(φ_{w}/φ_{b});
calculating inertial lift (J_{I}) for all particles, where J_{Ib =0.036ρα}³γ²η;
calculating shear induced diffusion (J_{S}) for all particles, where J_{S}=0.078(α⁴/L)^{1/3}γ ln(φ_{w}/φ_{b}), and wherein γ is wall shear rate (s⁻¹), κ is Boltzmann constant (J/mol K), T is temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³); and
selecting Jmax for each particle, wherein Jmax=uᵢ, thereby determinig maximum back-transport for each particle.

46. The method according to claim 40, wherein said estimating maximum aggregate packing volume fraction (φ_{M}) at the membrane wall for a suspension comprises:
determining particle size (αᵢ) of species (i) in the suspension;
determining if the size ratio of the particles is >10, such that αᵢ₊₁>10αᵢ for all αᵢ; and
calculating the maximum aggregate pacling volume fraction (φ_{Mm}) by
φ_{Mn}=φₘ+φₘ(1−φ_{Mn-1}), where φ_{M}=φₘ set to 0.64, when the size ratio the particles is >10, such that αᵢ₊₁>10αᵢ for all αᵢ.

47. The method according to claim 40, wherein the suspension comprises 3 particle sizes and wherein a₁>10α₂>100α₃, said method further comprising:
calculating φ_{M}=φₘ+φₘ(1−φₘ) +0.74[1−{φₘ+φₘ(1−φₘ)}],
wherein φ_{wi} is the maximum packing volume fraction for monodisperse spheres set to 0.64.

48. The method according to claim 40, wherein said estimating maximum aggregate packing volume fraction (φ_{M}) at the membrane wall comprises:
calculating a maximum radius ratio of all particles;
determiniig if said maximum radius ratio is <10; and
setting φ_{M}as 0.68, where said maximum radius ratio is <10.

49. The method according to claim 40, wherein said estimating maximum aggregate packing volume fraction (φ_{M}) at the membrane wall for a suspension comprising two particles, such that α₁>10 α₂, is carried out by calculating φ_{M}=φₘ+0.74(1−φₘ), where φₘ is set to 0.64.

50. The method according to claim 40, wherein said selecting the particle that gives a minimum permeation flux (J) comprises:
calculating Brownian diffusion (J_{B}) for all particles, where
J_{B}=0.114(γκ²T²/η²α²L)^{1/3} ln(φ_{w}/φ_{b});
calculating inertial lift (J_{I}) for all particles, where J_{I}=0.036ρα³γ²/η;
calculating shear induced diffusion (J_{S}) for all particles, where J_{S}=0.078(α⁴/L)^{1/3}γ ln(φ_{w}/φ_{b}), wherein γ is wall shear rate (s⁻¹), η is Boltzmann constant (J/mol K), T is temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³);
determining a Jmax value for each particle; and
selecting a Jₘₐₓ value from among all Jmax values that is the lowest thereby selecting the minimum permeation flux (j).

51. The method according to claim 40, wherein said determining packing density at the membrane wall (φ_{wj}) for all particles at the predicted permeation flux (αⱼ for j≠i) comprises:
back-calculating the value of φ_{wj} such that φ_{wj} gives the predicted permeation flux (J) of selected particle (aᵢ), using the equation for back-transport that establishes maximum back transport for each particle (αⱼ for j=i), wherein the equation is either J_{B}=0.114(γκ²T²/η²α²L)^{1/3} ln(φ_{w}/φ_{b}) or J_{S}=0.078(α⁴/L)^{1/3}γ ln(φ_{w}/φ_{b}), or J_{I}=0.036ρα³γ²/η, where γ is wall shear rate (s⁻¹), κ is Boltzmann constant (J/mol K), Tis temperature (K), η is bulk fluid viscosity (kg/m.s), αᵢ is radius of species i(m), L is tube length (m), φ_{w} is particle volume fraction at the membrane wall (−), φ_{b} is the particle volume fraction in the bulk suspension (−), and ρ is particle density (kg/m³).

52. The method according to claim 51, wherein said determining packing density further comprises:
determining if the predicted permeation flux is established by inertial lift (J_{I}) for one particle type;
determining if u_{jI}≧10J; and
setting φ_{wj}=0, when one particle type is established by inertial lift (J_{I}) and u_{jI}≧10J_{I}.

53. The method according to claim 51, wherein said determining packing density furtlier comprises:
determining if the predicted permeation flux is established by inertial lift (J_{I}) for one particle type;
determining if u_{jI}<10J; and
determning packing density (φ_{wj}) by φ_{wjI}=φ_{M}−Σφ_{wj} when u_{jI}<10J and one particle type is established by inertial lift.

54. The method according to claim 51, wherein said determining packing density further comprises:
determining if permeation flux is established by inertial lift (J_{I}) for more than one particle type;
determining if u_{jI}<10J for the particles; and
determining packing density by φ_{wjI}=φ_{M}−Σφ_{wj} when u_{jI}<10J and permeation flux is established by inertial lift for more than one particle type.

55. The method according to claim 51, wherein said determining packing density further comprises:
determining if permeation flux is established by J_{I} for more than one particle type (jI1, jI2, . . . jIn); and
determining packing density at the membrane wall by
φ_{wjI1}+φ_{wjI2}=φ_{M}−Σφ_{wj}, wherein φ_{wjI1}:φwjI2=φ_{bjI1} uⱼᵢ₂: φ_{bjI2} u_{jI1},
where j≠jI1 or jI2 and u_{jI1}, u_{jI2}<10J, when permeation flux is established by J_{I} for more than one particle type.

56. The method according to claim 40, wherein filtration is selected from the group consisting of microfiltration and ultrafiltration.

57. A method for calculating yield of a target molecule in a permeate for a poly-disperse suspension during crossflow membrane filtration, said method comprising:
determining minimum pore diameter (2rₘᵢₙᵢₘᵤₘ) based on the packing density of each particle and
estimating yield of a target species in the filtration permeate by calculating observed sieving coefficient (Sₒ) for the target species.

58. The method according to claim 57, further comprising:
refining the yield and pressure independent permeation flux.

59. The method according to claim 57, wherein said refining the yield comprises:
determining whether the suspension has a low, intermediate, or high operating shear rate leading to different yield regimes, wherein a suspension at a low operating shear rate leads to an Sₒ>0.75 corresponding to a yield ≧0.95, an intermediate operating shear rate leads to 0<Sₒ<0.75 corresponding to yield from 0 to 95%, or a high operating shear rate leads to an Sₒ≅0, wherein Sₒ=S_{α}/((1−S_{α})exp(−J/k)+S_{α}), wherein actual sieving coefficient S_{α} is obtained from S_{α}=(S_{∝}exp(Peₘ))/(S_{∝}+exp(Peₘ)−1), wall Peclet number, Peₘ is obtained from Peₘ=(Jδₘ/D)(S_{∝}/εφK_{d}), where J is permeation flux (m/s), δₘ is taken as the side of the face centered cube of the particles of radius αᵢ that forms the controlling cake for transmission, where δₘ=α=αᵢ[(4(4/3)π)/φ_{iinterslice}]^{1/3}, D is molecular diffusion coefficient (m²/s), intrinsic sieving coefficient S₄ is obtained from S_{∝}=(1−λ)²[2−(1−λ)²] exp(−0.7146λ²), λ=rₛ/rₘᵢₙ, where rₛ is solute radius (m) and rₘᵢₙ is a minimum equivalent cake void radius for all cake types (m), φ is equilibrium partition coefficient between membrane pore and suspension (−), ε is cake/membrane porosity (−), K_{d} is hindrance factor for diffusive transport (−), and k is mass transfer coefficient (m/s).

60. The method according to claim 59, wherein an intermediate operating shear rate is determined as leading to 0<Sₒ<0.75, said method further comprising:
calculating stagnant film flux (J) equation for non-retentive membranes wherein J=k ln [(φ_{wi}−φₚₑᵣₘₑₐₜₑᵢ)/(φ_{bi}−φₚₑᵣₘₑₐₜₑᵢ)]≅k ln[φ_{wi}/φ_{bi}(1−Sₒ)], wherein (φ_{wi}>>φₚₑᵣₘₑₐₜₑᵢ); and
correcting Sₒ by replacing J=solvent permeation flux (m/s) with the stagnant film flux (J) equation for non-retentive membranes in the equation for observing sieving coefficient, Sₒ, where Sₒ=S_{α}/((1−S_{α})exp(−J/k)+S_{α}).

61. The method according to claim 57, wherein determining minimum pore diameter (2rₘᵢₙᵢₘᵤₘ) is carried out using
2rₘᵢₙᵢₘᵤₘ=αᵢ{√2[4(4/3)π/φ_{wiinterslice}]^{1/3}−2}, where α is the radius of species i(m) and rₘᵢₙᵢₘᵤₘ,umis a minimum equivalent cake void radius for all cake types (m).

62. The method according to claim 57, wherein said estimating yield of a target species comprises:
calculating observed sieving coefficient (Sₒ), where Sₒ=S_{α}/((1−S_{α})exp(−J/k)+S_{α}), wherein actual sieving coefficient S_{α} is obtained from S_{α}=(S_{∝}exp(Peₘ))/(S_{∝}+exp(Peₘ)−1), wall Peclet number, Peₘ is obtained from Peₘ=(Jδₘ/D)(S_{∝}/εφK_{d}), where Jis permeation flux (m/s), δₘ is taken as the side of the face centered cube of the particles of radius αᵢ that forms the controlling cake for transmission, where δₘ=α=αᵢ[(4(4/3)π)/φ_{iinterslice}]^{1/3}, D is molecular diffusion coefficient (m²/s), intrinsic sieving coefficient S_{∝} is obtained from S_{∝}=(1−λ)²[2−(1−λ)²]exp(−0.7146λ²), λ=rₛ/rₘᵢₙ, where rₛ is solute radius (m) and rₘᵢₙ is a minimum equivalent cake void radius for all cake types (m), φ is equilibrium partition coefficient between membrane pore and suspension (−), ε is cake/membrane porosity (−), K_{d} is hindrance factor for diffusive transport (−), and k is mass transfer coefficient (m/s).

63. The method according to claim 57, wherein crossflow filtration is carried out in a diafiltration mode, said the yield of the target species after N_{d} diavolumes is estimated by Yield=1−exp(−N_{d}S_{oaverage}), where S_{oaverage} is average observed sieving coefficient during diafiltration (−), where Sₒ=S_{α}/((1−S_{α})exp(−J/k)+S_{α}), where actual sieving coefficient S_{α} is obtained from S_{α}=(S_{∝}exp(Peₘ))/(S_{∝}+exp(Peₘ)−1), wall Peclet number, Peₘ is obtained from Peₘ=(Jδₘ/D)(S_{∝}/εφK_{d}), where J is permeation flux (m/s), δₘ is taken as the side of the face centered cube of the particles of radius αᵢ that forms the controlling cake for transmission, where δₘ=α=αᵢ[(4(4/3)π)/φ_{iinterslice}]^{1/3}, D is molecular diffusion coefficient (m²/s), intrinsic sieving coefficient S_{∝} is obtained from S_{∝}=(1−λ)²[2−(1−λ)²exp(−0.7146λ²), λ=rₛ/rₘᵢₙ, where rₛ is solute radius (m) and rₘᵢₙ is a minimum equivalent cake void radius for all cake types (m), and φ is equilibrium partition coefficient between membrane pore and suspension (−), ε is cake/membrane porosity (−), K_{d} is hindrance factor for diffusive transport (−), and k is mass transfer coefficient (m/s).

64. The method according to claim 57, wherein filtration is selected from the group consisting of microfiltration and ultrafiltration.

65. The method according to claim 57, wherein filtration is carried out with a filter selected from the group consisting of a flat sheet filter, hollow-fiber filter, and a helical filter.

66. The method according to claim 57, wherein the suspension is selected from the group consisting of streams from biomedical and bio- processing industries, waste water, surface water, environmental pollutants, industrial waste streams, and industrial feed streams.

67. The method according to claim 66, wherein the suspension is a stream from biomedical and bio-processing industries selected from the group consisting of proteins, cells, nucleic acids, colloids, milk, and suspended particles.

68. A method for designing a crossflow membrane filtration system for a poly-disperse suspension, said method comprising:
selecting a poly-disperse suspension;
applying the method according to claim 1 to predict pressure independent permeation flux and target molecule yield in a permeate for the selected poly-disperse suspension; and
optimizing conditions for filtration based on the prediction of permeation flux and target molecule yield to design a filtration system for the selected poly-disperse suspension.

69. The method according to claim 68, wherein filtration is selected from the group consisting of microfiltration and ultrafiltration.

70. The method according to claim 68, wherein filtration is carried out with a filter selected from the group consisting of a flat sheet filter, hollow-fiber filter, and a helical filter.

71. A method of selecting operating conditions of a crossflow filtration system for poly-disperse suspensions, said method comprising:
applying the method of claim 1 to a crossflow filtration system for a selected poly-disperse suspension to determine a limiting pressure independent permeation flux for a given shear rate and expected yield of a target species for the selected system conditions and selecting the operating conditions of the system using the determined limiting pressure independent permeation flux for a given shear rate to obtain an optimal balance between permeation flux and yield of a target species.

72. The method according to claim 71, wherein filtration is selected from the group consisting of microfiltration and ultrafiltration.

73. The method according to claim 71, wherein filtration is carried out with a filter selected from the group consisting of a flat sheet filter, hollow-fiber filter, and a helical filter.

74. The method according to claim 71, wherein the suspension is selected from the group consisting of waste water, surface water, environmental pollutants, industrial waste streams, and industrial feed streams.

75. A method of modeling a process for filtration of a poly- disperse suspension comprising:
applying the method according to claim 1 for a poly-disperse suspension using a computer-generated program to model a process for filtration of the poly-disperse suspension.

76. The method according to claim 75, wherein filtration is selected from the group consisting of microfiltration and ultrafiltration.

77. The method according to claim 75, wherein filtration is carried out with a filter selected from the group consisting of a flat sheet filter, hollow-fiber filter, and a helical filter.

78. The method according to claim 75, wherein the suspension is selected from the group consisting of streams from biomedical and bio- processing industries, waste water, surface water, environmental pollutants, industrial waste streams, and industrial feed streams.

79. The method according to claim 78, wherein the suspension is a stream from biomedical and bio-processing industries selected from the group consisting of proteins, cells, nucleic acids, colloids, milk, and suspended particles.
